(19) United States
(12) Patent Application Publication
(10) Pub. No.: US 2023/0324522 A1
(43) Pub. Date: Oct. 12, 2023

(54) CLOCKED ACTIVE QUENCH/RECHARGE AND GAIN CELL MEMORY PIXEL

(71) Applicants: Sense Photonics, Inc., Durham, NC (US); The University Court of The University of Edinburgh, Edinburgh (GB)

(72) Inventors: Robert Henderson, Edinburgh (GB); Tarek Al Abbas, Berkeley, CA (US); Hod Finkelstein, Berkeley, CA (US)

(21) Appl. No.: 18/044,101

(22) PCT Filed: Sep. 7, 2021
(86) PCT No.: PCT/US2021/049194

§ 371 Date: Mar. 6, 2023

Related U.S. Application Data
(60) Provisional application No. 63/231,009, filed on Aug. 9, 2021.
(60) Provisional application No. 63/077,101, filed on Sep. 11, 2020.

(51) Int. Cl. G01S 7/4863; G01S 17/894

(52) U.S. Cl. CPC G01S 7/4863; G01S 17/894

(57) ABSTRACT

A Light Detection and Ranging (LIDAR) detector circuit includes one or more photodetector elements configured to output respective detection signals indicating respective detection events responsive to light incident thereon, and at least one control circuit. The at least one control circuit is configured to receive the respective detection signals from the one or more photodetector elements, and to reset the one or more photodetector elements responsive to a transition of a clock signal after the respective detection events. Related memory devices and systems are also discussed.

### CLAIM OF PRIORITY

This application claims priority from U.S. Provisional Patent Application Ser. No. 63/077,101, filed Sep. 11, 2020, the disclosure of which is incorporated by reference herein in its entirety.

### FIELD

The present disclosure is directed to Light Detection and Ranging (LIDAR; also referred to as lidar) systems, and more particularly, to time-of-flight lidar systems.

### BACKGROUND

Time of flight (ToF) based imaging is used in a number of applications including range finding, depth profiling, and 3D imaging (e.g., lidar). Direct time of flight (dToF) measurement includes directly measuring the length of time between emitting radiation and sensing the radiation after reflection from an object or other target. From this, the distance to the target can be determined. Indirect time of flight (iToF) measurement includes determining the distance to the target by phase modulating the amplitude of the signals emitted by emitter element(s) of the lidar system and measuring phases (e.g., with respect to delay or shift) of the echo signals received at detector element(s) of the lidar system. These phases may be measured with a series of separate measurements or samples.

In specific applications, the sensing of the reflected radiation in either direct or indirect time of flight systems may be performed using an array of photodetectors, such as an array of single photon detectors, for example, Single Photon Avalanche Diodes (SPADs). One or more photodetectors may define a detector pixel of the array. SPAD arrays may be used as solid-state detectors in imaging applications where high sensitivity and timing resolution may be required.

A SPAD is based on a semiconductor junction (e.g., a p-n junction) that may detect incident photons when biased beyond its breakdown region (also referred to as excess bias or overbias), for example, by or in response to a strobe signal having a desired pulse width. The high reverse bias voltage generates a sufficient magnitude of electric field such that a single charge carrier introduced into the depletion layer of the device can cause a self-sustaining avalanche via impact ionization. The avalanche is quenched by a quench circuit, either actively (e.g., by reducing the bias voltage) or passively (e.g., by using the voltage drop across a serially connected resistor), to allow the photodetector to be recharged (to a bias voltage above breakdown, by charging the SPAD device capacitance) or “reset” to detect further photons. The recharge operation may likewise be performed actively (e.g., using an active circuit element to switch current through a low resistance path) or passively (e.g., by ramping the voltage across the photodetector through a serially connected RC circuit). The initiating charge carrier can be photo-electrically generated by a single incident photon striking the high field region. It is this feature which gives rise to the name ‘Single Photon Avalanche Diode’. This single photon detection mode of operation is often referred to as ‘Geiger Mode’.

When imaging a scene, ToF sensors for LIDAR applications can include circuits that time stamp and/or count incident photons as reflected from a target. Some ToF pixel approaches may use digital and/or analog circuits to count the detection of photons and the arrival times of photons, also referred to as time-stamping, which may be stored in a memory.

Data rates can be compressed by histogramming timestamps; however, this can involve considerable memory resources which may be inefficiently used in typical ToF LIDAR systems. In histogramming memory applications, such inefficiencies can involve (but are not limited to) the number of detector pixels (where more transistors per memory cell or pixel may cause surface area peak power requirements to increase), memory or bit depth (e.g., the number of bits) of each histogram bin (which may correspond to a subrange of photon arrival times), and the number of histogram bins that may be required to cover the typical time range of a LIDAR system (e.g., on the order of microseconds).

Static Random Access Memory (SRAM) may be used for memory storage. SRAM (e.g., where a single bit may be represented by 6 transistors) is many times more compact per bit than some counters that may be conventionally applied to SPAD pixels (where a single bit in a counter may be represented by a D-type (or T-type) flip-flop with around 32 transistors). In addition a readout cell (e.g., a tristate buffer) may be used per bit. SRAM may involve challenges, however, in that the read-increment-write logic conventionally incorporated in some SRAM configurations may be large and difficult to incorporate in smaller pixel due to layout/space limitations, particularly as speed and storage requirements increase.

### SUMMARY

Some embodiments described herein provide a lidar system including one or more emitter units (including one or more semiconductor lasers, such as surface- or edge-emitting laser diodes; generally referred to herein as emitters, which output emitter signals), one or more light detector pixels (including one or more photodetectors, such as semiconductor photodiodes, including avalanche photodiodes and single-photon avalanche detectors; generally referred to herein as detectors, which output detection signals in response to incident light), and one or more control circuits that are configured to selectively operate subsets of the emitter units and/or detector pixels (including respective emitters and/or detectors thereof, respectively) to provide a 3D time of flight (ToF) flash lidar system.

In some embodiments, the control circuit(s) includes a photodetector control circuit that is configured to receive respective detection signals from one or more photodetector elements, and to perform a quench and reset operation that resets the one or more photodetector elements responsive to a transition of a clock signal after a detection event. The clock signal may be a global clock signal that is configured to control output of pulses of an emitter signal from a lidar emitter or emitter array. That is, the photodetector control circuit may be configured to quench and reset the one or more photodetectors upon a next pulse of the global clock signal after a detection event.

In some embodiments, the control circuit(s) includes a memory control circuit that is configured to execute an increment operation to update data indicative of detection events that is stored in respective memory bins defined by memory cells of a non-transitory memory device, responsive to respective detection signals indicating occurrence of the detection events. The memory control circuit includes a logic-based counter circuit (e.g., a linear feedback shift register) that is configured to perform the increment operation by charge sharing between a storage element of a respective memory cell of the memory device and a bit line of a preceding memory cell (e.g., in the same row of the memory device), where the capacitance of the bit line may be much greater than the capacitance of the storage element.

According to some embodiments of the present disclosure, a Light Detection and Ranging (LIDAR) detector circuit includes one or more photodetector elements configured to output respective detection signals indicating respective detection events responsive to light incident thereon; and at least one control circuit configured to receive the respective detection signals from the one or more photodetector elements, and to reset the one or more photodetector elements responsive to a transition of a clock signal after the respective detection events.

In some embodiments, the clock signal may be a global clock signal that is configured to control output of pulses of an emitter signal from a LIDAR emitter element or emitter array.

In some embodiments, the at least one control circuit may include a sampling circuit that is configured to sample the respective detection signals responsive to the global clock signal to generate a sampled detection signal, and a reset circuit that is configured to reset the one or more of the photodetector elements responsive to the sampled detection signal.

In some embodiments, the sampling circuit may include a logic circuit that is free of delay logic.

In some embodiments, the at least one control circuit may be configured to reset the one or more photodetector elements responsive to the transition of the clock signal and after respective delay times that are associated with the one or more photodetector elements.

In some embodiments, the one or more photodetector elements may be detectors of a same detector pixel of a LIDAR detector array, and the respective delay times of the detectors of the same detector pixel may differ from one another.

In some embodiments, the one or more photodetector elements may be detectors of different detector pixels of a LIDAR detector array, and the respective delay times of the detectors of the different detector pixels may differ from one another.

In some embodiments, the one or more photodetector elements may be detectors of different groups of detector pixels of a LIDAR detector array, and the respective delay times of the detectors of the different groups of the detector pixels may differ from one another.

In some embodiments, the at least one control circuit may include a sampling and delay circuit that is configured to sample the respective detection signals responsive to the clock signal to generate sampled detection signals and to offset the sampled detection signals by the respective delay times, and a reset circuit that is configured to reset the one or more of the photodetector elements responsive to the sampled detection signals that are offset by the delay circuit.

In some embodiments, the sampling and delay circuit may include one or more delay elements having respective timing offsets associated therewith, and the one or more delay elements may be selectable responsive to a delay select signal.

In some embodiments, the one or more photodetector elements may be configured to operate at a different voltage level than the reset circuit. The at least one control circuit may further include a bias circuit that is coupled between an output of the one or more photodetector elements and the reset circuit. The reset circuit and the bias circuit may be free of voltage level shift electronics.

In some embodiments, the reset circuit may include a reset transistor that is coupled to the output of the one or more photodetector elements. The bias circuit may include a bias transistor that is coupled in a cascode arrangement between the output of the one or more photodetector elements and the reset transistor.

In some embodiments, the one or more photodetector elements may be detectors of a same detector pixel of a LIDAR detector array, and the at least one control circuit may be configured to reset the one or more photodetector elements responsive to the transition of the global clock signal after a first one of the respective detection events.

In some embodiments, a memory device may be provided by a non-transitory storage medium including a plurality of memory cells and may be configured to store data in respective memory bins comprising one or more of the memory cells. The at least one control circuit may further include a memory control circuit configured to execute an increment operation to update the data in the respective memory bins responsive to the respective detection events.

In some embodiments, the memory control circuit may be a logic-based counter circuit that is configured to perform the increment operation by connecting a storage element of a respective one of the memory cells to a bit line of a preceding one of the memory cells in a same row or column of the memory device. A capacitance of the bit line may be greater than a capacitance of the storage element.

In some embodiments, the logic-based counter circuit may include a linear feedback shift register that is configured to execute the increment operation by sequentially shifting the data stored in the storage element of the respective one of the memory cells to a bit line of a succeeding one of the memory cells in the row using a linear feedback loop.

According to some embodiments of the present disclosure, a Light Detection and Ranging (LIDAR) detector circuit includes a memory device comprising a non-transitory storage medium including a plurality of memory cells configured to store data in respective memory bins comprising one or more of the memory cells; and at least one control circuit configured to execute an increment operation to update the data in the respective memory bins by connecting a storage element of a respective memory cell of the memory cells to a bit line of a preceding memory cell of the memory cells in a same row or column of the memory device.

In some embodiments, the respective memory cell may include a transistor that is configured to be switched to connect the storage element thereof with the bit line of the preceding memory cell. A capacitance of the bit line may be greater than a capacitance of the storage element.

In some embodiments, the at least one control circuit may further include a photodetector interface circuit that is configured to receive respective detection signals from one or more photodetector elements. The at least one control circuit may be configured to execute the increment operation to update the data in the respective memory bins responsive to respective detection events indicated by the respective detection signals, and to reset the one or more photodetector elements responsive to transition of a clock signal after the respective detection events. The clock signal may be configured to control output of pulses of an emitter signal from a LIDAR emitter element.

In some embodiments, the at least one control circuit may include a logic-based counter circuit that is configured to execute the increment operation responsive to the respective detection events.

In some embodiments, the logic-based counter circuit may include a linear feedback shift register that is configured to execute the increment operation by sequentially shifting the data stored in the storage element of the respective memory cell to a bit line of a succeeding memory cell in the same row or column of the memory device using a linear feedback loop.

According to some embodiments of the present disclosure, a Light Detection and Ranging (LIDAR) detector circuit includes a detector array comprising a plurality of photodetector elements configured to output respective detection signals indicating respective detection events responsive to light incident thereon; a memory device comprising a non-transitory storage medium including a plurality of memory cells configured to store data in respective memory bins comprising one or more of the memory cells; and at least one control circuit configured to receive the respective detection signals from the photodetector elements, and to execute an increment operation to update the data in the respective memory bins responsive to the respective detection events. The at least one control circuit includes a photodetector control circuit configured to reset the photodetector elements responsive to a transition of a clock signal after the respective detection events; and/or a memory control circuit configured to execute the increment operation by connecting a storage element of a respective memory cell of the memory cells to a bit line of a preceding memory cell of the memory cells in a same row or column of the memory device.

In some embodiments, the clock signal may be a global clock signal that is configured to control output of pulses of an emitter signal from a LIDAR emitter element or emitter array. In some embodiments, the photodetector control circuit may be configured to reset the photodetector elements responsive to the transition of the clock signal and after respective delay times that are associated with the photodetector elements.

In some embodiments, the at least one control circuit may include a sampling circuit that is configured to sample the respective detection signals responsive to the global clock signal to generate sampled detection signals; and a reset circuit that is configured to reset the photodetector elements responsive to the sampled detection signals.

In some embodiments, the sampling circuit may further include a delay circuit that is configured to offset the sampled detection signals by the respective delay times. The reset circuit may be configured to reset the photodetector elements responsive to the sampled detection signals that are offset by the delay circuit.

In some embodiments, the memory device may be a memory array comprising respective rows or columns of dynamic random access memory (DRAM) cells that define the respective memory bins. The at least one control circuit may further be configured to output a readout signal responsive to a read signal that is sequentially applied to the respective rows or columns.

In some embodiments, the readout signal may include a count signal and/or a time integration signal, and the at least one control circuit may be configured to calculate an estimated time of arrival of photons incident on the photodetector elements based on the readout signal.

In some embodiments, the at least one control circuit may be configured to transmit respective strobe signals that activate the photodetector elements for respective detection windows that are differently delayed between pulses of an emitter signal that are generated responsive to the clock signal. The respective detection windows may correspond to respective distance subranges, and the at least one control circuit may be configured to transmit the respective strobe signals to activate the photodetector elements to sequentially cycle through the respective distance subranges.

In some embodiments, the one or more photodetector elements may be one or more single photon avalanche diodes (SPADs).

In some embodiments, the LIDAR system may be configured to be coupled to an autonomous vehicle such that one or more emitter elements and the one or more photodetector elements are oriented relative to an intended direction of travel of the autonomous vehicle.

Other devices, apparatus, and/or methods according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF THE DRAWINGS

FIG. 1 is a schematic block diagram illustrating an example of a LIDAR system or circuit in accordance with embodiments of the present disclosure.

FIG. 2 is a schematic block diagram illustrating components of a ToF measurement system or circuit in a LIDAR application in accordance with some embodiments of the present disclosure.

FIGS. 3 and 4 are schematic block diagrams illustrating example configuration of memory circuits implementing a DRAM-based pixel in accordance with some embodiments of the present disclosure.

FIG. 5A is a schematic diagram illustrating an example clocked active quench circuit in accordance with some embodiments of the present disclosure.

FIG. 5B is a timing diagram illustrating states of the signals shown in FIG. 5A.

FIG. 6A is a schematic diagram illustrating an example memory device including 3T DRAM cells in accordance with some embodiments of the present disclosure.

FIGS. 6B, 6C, and 6D are enlarged views illustrating operation of a precharge circuit and a row of the memory device of FIG. 6A during precharge, read, and write cycles, respectively, in accordance with some embodiments of the present disclosure.

FIG. 7A is a schematic diagram illustrating an example circuit that is configured to perform increment and refresh operations according to some embodiments of the present disclosure.

FIG. 7B is a timing diagram illustrating the states of the signals shown in FIG. 7A.

FIG. 8A is a schematic diagram illustrating an example circuit that is configured to perform increment and refresh operations according to some embodiments of the present disclosure.

FIG. 8B is a timing diagram illustrating the states of the signals shown in FIG. 8A.

FIG. 9 is a schematic diagram illustrating folding and partitioning configurations that are configured to reduce bit line capacitance according to some embodiments of the present disclosure.

FIGS. 10, 11, 12, 13, 14, and 15 are schematic diagrams illustrating example memory usage schemes according to some embodiments of the present disclosure.

FIGS. 16A and 16B are schematic diagrams illustrating an example of a multi-SPAD detector pixel with LFSR-based counting using a partial ALU according to some embodiments of the present disclosure. FIG. 16C is a timing diagram illustrating the states of the signals in the operations of FIGS. 16A and 16B.

FIG. 17A is a schematic diagram illustrating an example clocked active recharge circuit in accordance with some embodiments of the present disclosure.

FIG. 17B is a timing diagram illustrating operation of a detector pixel including clocked active recharge circuits as shown in FIG. 17A.

### DETAILED DESCRIPTION

In the following detailed description, numerous specific details are set forth to provide a thorough understanding of embodiments of the present disclosure. However, it will be understood by those skilled in the art that the present disclosure may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Embodiments of the present disclosure are described herein with reference to lidar applications and systems. A lidar system may include an array of emitters and an array of detectors, or a system having a single emitter and an array of detectors, or a system having an array of emitters and a single detector. As described herein, one or more emitters may define an emitter unit, and one or more detectors may define a detector pixel. A detector pixel may also include or provide outputs to dedicated circuits, such as storage and logic circuits, which are not shared with other pixels, referred to herein as an “in-pixel” configuration. A flash lidar system may acquire images by emitting light from an array of emitters, or a subset of the array, for short durations (pulses) over a field of view (FoV) or scene, and detecting the echo signals reflected from one or more targets in the FoV at one or more detectors. A non-flash or scanning lidar system may generate image frames by raster scanning light emission (continuously) over a field of view or scene, for example, using a point scan or line scan to emit the necessary power per point and sequentially scan to reconstruct the full FoV.

In embodiments described herein, a detection window or strobe window may refer to the respective durations of activation and deactivation of one or more detectors (e.g., responsive to respective detector time gates/control signals from a control circuit) over a temporal period or time between pulses of the optical signal output by the emitter(s) (also referred to as the emitter signal, which may likewise be responsive to respective emitter control signals from a control circuit). The relative timings and durations of the respective detection windows may be controlled by respective strobe signals as described herein, in which case the detection windows may be referred to as strobe windows. A clock signal (Clk) may be used to synchronize the emitter control signals and the strobe signals, to ensure that the detectors are activated to detect photons at the desired times between the pulses of the emitter signal (which may correspond to respective distance subranges of the overall imaging range of the lidar system).

Some detector pixel implementations may include limitations as to surface area-per-bit and power-per-bit. For example, some circuits may include active quench (AQ) and edge sampler circuits, which may have significant area and power consumption. In particular, an active quench circuit may include delay cells (which may delay the resetting or “quenching” of a SPAD responsive to a detection event) and level shifters (which may shift the (typically higher) voltage levels of the SPAD output signals down and the (typically lower) voltage levels used by the logic circuit up, for compatibility with one another) that may be responsible for excess power consumption.

Also, arithmetic logic units (ALU) and differential SRAM read-increment-write logic circuits may consume significant circuit area. For example, the logic required to precharge, read, modify, and write (PRMW) an SRAM-based detector pixel (some of which may include six transistors (NMOS and PMOS) per SRAM cell; also referred to as 6T) may be relatively complex and area-consuming. Address generation and clock generation may also have significant area consumption.

In addition, binary arithmetic carry chain settling may limit binary counting and arithmetic logic unit (ALU) cycle time. For example, some binary counters may use a k-bit carry chain, which may require k gate delays to settle if implemented with chained full-adders (e.g., whereby the carry output (Co) of one full adder is connected to the carry input (Ci) of the next full adder). However, such a configuration may make it difficult to settle within or inside about half of a bin time (i.e., with respect to a bin update clock cycle) in some instances, which can thus impose limitations on the histogram bin widths (e.g., limiting bin times to about 4 ns) and associated depth resolution.

Some embodiments of the present disclosure may arise from realization that, in some lidar applications, memory may be accessed sequentially, e.g., by stepping progressively through and updating time bins in real time with incoming photon counts returning from the laser pulse reflected from a target responsive to continuously or periodically applying a control signal to an emitter unit and applying a strobe signal to a detector pixel to cycle through a series of distance sub-ranges. In contrast, in some conventional uses of SRAM, data states may typically be held for unpredictable time durations set by sporadic access by an external system, and the memory access may be random.

Accordingly, some embodiments of the present disclosure provide detector pixels including memory array implementations and related control schemes that use sequential memory access operations that are coordinated with the cycling through the series of distance sub-ranges performed by lidar detector pixels, as well as with the time between pulses of a lidar emitter signal. Some embodiments of the present disclosure may use Dynamic Random Access Memory (DRAM)-based memory arrays for the detector pixels, with memory refresh operations performed at a sufficient refresh rate (e.g., once per emitter signal cycle, once every two emitter signal cycles, etc.) to prevent leakage of the stored value in each DRAM cell.

Embodiments of the present disclosure are further directed to improvements in circuit area and power consumption requirements in lidar applications, particularly with respect to the size and complexity of the active quench, edge sampler, PRMW, and address generator logic circuits. In particular, embodiments of the present disclosure may combine the functionality of the active quench and edge sampler circuits (and the generation of the precharge signal for the PRMW logic circuits) by synchronizing the active quench operations using a clock signal, rather than by using delay elements. Also, memory modify (i.e., increment or refresh) operations may be effectively performed by charge sharing between adjacent memory cells.

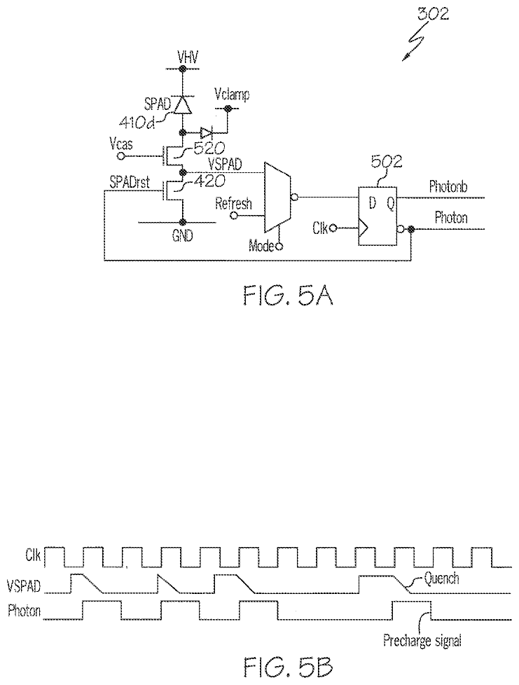

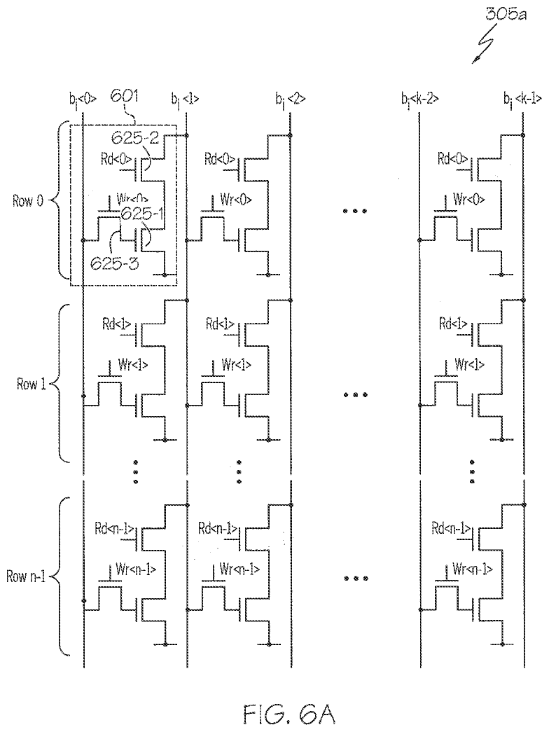

Accordingly, some embodiments of the present disclosure may provide detector pixels including memory array implementations and related control schemes that allow for the use of the clock signal to reset or “quench” each SPAD, with the state of each SPAD being held on its own capacitance. As used herein, a quench circuit may describe one or more circuits that are configured to perform sampling, quenching, and/or recharge operations as described herein. For example (with reference to FIG. 4), a clocked active quench circuit may be implemented by coupling the detection signal (V SPAD) that is output from a photodetector (e.g., a SPAD 410d) to a logic circuit 302 (e.g., including a flip-flop 502) that is sampled by the global clock signal (Clk; which may also control operation of the emitter elements and/or bin widths) to provide the quench signal (SPADRst; also referred to herein as a reset or recharge signal) to a reset circuit 420 (e.g., a reset transistor) that resets the photodetector. As such, the functionality of an active quench/reset circuit and an edge sampler circuit may be combined using a global clock signal Clk, rather than by using delay cells, with little if any loss in performance when the clock period of the same order as (e.g., within a few nanoseconds of) the photodetector dead time. Level shifters may also be eliminated, as each SPAD 410d may hold its state on its own parasitic capacitance, and (with reference to FIG. 5A) a cascode transistor arrangement 520 may be provided between the output of the SPAD 410d and the reset transistor 420. The reset transistor 420 may be biased in a linear mode to provide a resistive quench element, and the reset or quench and recharge signal (SPADRst) may be used to recharge the capacitance of the SPAD.

Additionally or alternatively, some embodiments of the present disclosure may provide detector pixels including memory array implementations and related control schemes that allow for memory increment or refresh operations to be performed using a logic-based counter circuit, such as linear-feedback shift register (LFSR)-based counting, rather than (or in addition to) ALU-based counting. LFSR based counting may only involve a cyclic shift operation where data is moved from one bit to the succeeding bit. This can eliminate the need for random input and output data transfer of a DRAM (or SRAM), which may require both input and output bit lines. Instead an output bit line may be shared or combined with the output bit line of the next bit in succession, which can eliminate a bit line as well as making it possible to share source/drain diffusions in the DRAM matrix leading to greater compactness.

For example, in some embodiments, a charge sharing memory array may be implemented by connecting (e.g., using a transistor switch) a bit line, which is coupled to the output of one memory cell, to the input (in particular, to the storage element) of an adjacent memory cell (with a feedback loop from the output of the last memory cell to the input of a first memory cell), thereby operating the memory cells as a linear feedback shift register (LFSR). Because the bit line capacitance (Cbl) is much greater than the capacitance (Cg) of the storage element (which may be implemented by the parasitic capacitance of a storage node transistor) of the adjacent memory cell, the charge sharing may overwrite the state held by the storage element. Increment or refresh operations may be triggered by the presence or absence of detected photons (e.g., as indicated by high or low states of signal (Photon) output from the clocked active quench circuit), respectively. As LFSR-based incrementing is a fast parallel operation (e.g., the read and write operations may be performed in parallel), binary carry chains may be eliminated. Also, address generation may be shared across many pixels, for example, using a read/write (Rd/Wr) Non-overlap Generator 450 that is shared between pixels (e.g., as shown in FIGS. 4 and 9).

Accordingly, some embodiments may allow for fully dynamic (i.e., where power may only be consumed by charging memory and SPAD parasitic capacitances) and fully synchronous (i.e., with no asynchronous activity on power supplies other than SPAD itself) SPAD pixels, using simplified per-SPAD memory increment electronics to allow for implementation of sub-10 micrometer (μm) pitch dToF pixels for short range ToF. This may allow for reduced-cost digital process compatibility (e.g., fewer requirements for eSRAM or eDRAM process modules). Fully dynamic operation of SPAD pixels (both detector and increment circuitry) may have the potential to reduce power consumption to physically achievable limits, which may be similar to figures of merit in ADC converters where fully dynamic successive approximation ADCs are close to theoretical energy consumption per operation limits. Such a dynamic pixel can target the theoretically achievable energy consumption limits per photon.

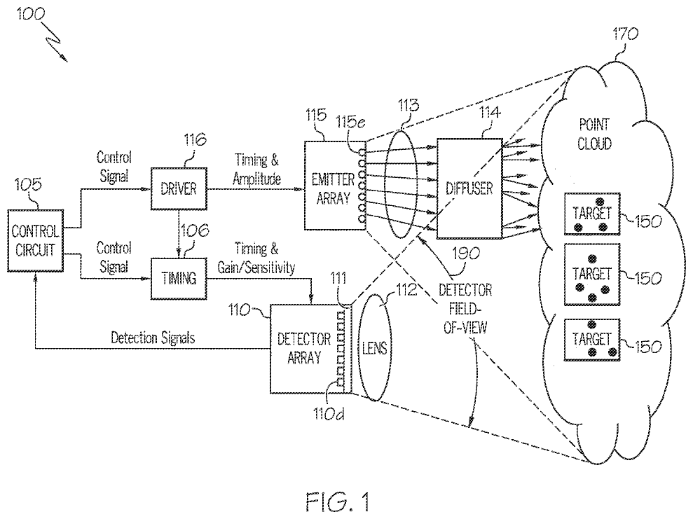

An example of a lidar system or circuit 100 that may utilize embodiments of the present disclosure is shown in FIG. 1. The lidar system 100 includes a control circuit 105, a timing circuit 106, an emitter array 115 including a plurality of emitters 115e, and a detector array 110 including a plurality of detectors 110d. The detectors 110d include time-of-flight sensors (for example, an array of single-photon detectors, such as SPADs). One or more of the emitter elements 115e of the emitter array 115 may define emitter units that respectively emit a radiation pulse or continuous wave signal (for example, through a diffuser or optical filter 114) at a time and frequency controlled by a timing generator or driver circuit 116. In particular embodiments, the emitters 115e may be pulsed light sources, such as LEDs or lasers (such as vertical cavity surface emitting lasers (VCSELs)). Radiation is reflected back from a target 150, and is sensed by detector pixels defined by one or more detector elements 110d of the detector array 110. The control circuit 105 implements a pixel processor that measures and/or calculates the time of flight of the illumination pulse over the journey from emitter array 115 to target 150 and back to the detectors 110d of the detector array 110, using direct or indirect ToF measurement techniques.

The driver electronics 116 may each correspond to one or more emitter elements, and may each be operated responsive to timing control signals with reference to a master or global clock (Clk) and/or power control signals that control the peak power of the light output by the emitter elements 115e. The driver circuit or circuitry 116 may include one or more driver transistors configured to control the modulation frequency, timing and amplitude of the optical emission signals that are output from the emitters 115e.

The emission of optical signals from multiple emitters 115e provides a single image frame for the flash LIDAR system 100. The maximum optical power output of the emitters 115e may be selected to generate a signal-to-noise ratio of the echo signal from the farthest, least reflective target at the brightest background illumination conditions that can be detected in accordance with embodiments described herein. An optional filter to control the emitted wavelengths of light, and optics 113 and diffuser 114 to increase a field of illumination of the emitter array 115 may be provided in some embodiments and are illustrated by way of example.

The receiver/detector module or circuit 110 includes an array of detector pixels (with each detector pixel including one or more detectors 110d, e.g., single photon detectors, such as SPADs), receiver optics 112 (e.g., one or more lenses to collect light over the FoV 190), and receiver electronics (including timing circuit 106) that are configured to power, enable, and disable all or parts of the detector array 110 and to provide timing signals thereto. The detector pixels can be activated or deactivated with at least nanosecond precision, and may be individually addressable, addressable by group, and/or globally addressable. In some embodiments, a spectral filter 111 may be provided to pass or allow passage of ‘signal’ light (i.e., light of wavelengths corresponding to those of the optical signals output from the emitters) but substantially reject or prevent passage of non-signal light (i.e., light of wavelengths different than the optical signals output from the emitters).

The detectors 110d of the detector array 110 are connected to the timing circuit 106. The timing circuit 106 may be phase-locked to the driver circuitry 116 of the emitter array 115, and may be controlled by the global clock (Clk). The sensitivity of each of the detectors 110d or of groups of detectors may be controlled. For example, when the detector elements include reverse-biased photodiodes, avalanche photodiodes (APD), PIN diodes, and/or Geiger-mode Avalanche Diodes (SPADs), the reverse bias may be adjusted, whereby, the higher the overbias, the higher the sensitivity.

Light emission output from one or more of the emitters 115e impinges on and is reflected by one or more targets 150, and the reflected light is detected as an optical signal (also referred to herein as a return signal, echo signal, or echo) by one or more of the detectors 110d (e.g., via receiver optics 112), converted into an electrical signal representation (referred to herein as a detection signal), and processed (e.g., based on time of flight) to define a 3-D point cloud representation 170 of the field of view 190. Operations of lidar systems in accordance with embodiments of the present disclosure as described herein may be performed by one or more processors or controllers, such as the control circuit 105 of FIG. 1.

The control circuit 105 may include a microcontroller or microprocessor that provides different emitter control signals to the driver circuitry 116 of different emitters 115e and/or provides different signals (e.g., strobe signals) to the timing circuitry 106 of different detectors 110d to enable/disable the different detectors 110d so as to detect the echo signal from the target 150. ‘Strobing’ as used herein may refer to the generation of detector control signals (also referred to herein as strobe signals or ‘strobes’) to control the timing and/or duration of activation (also referred to herein as detection windows or strobe windows) of one or more detectors 110d of the lidar system 100. The control circuit 105 may also control memory storage operations for storing data indicated by the detection signals in a non-transitory memory or memory array 205.

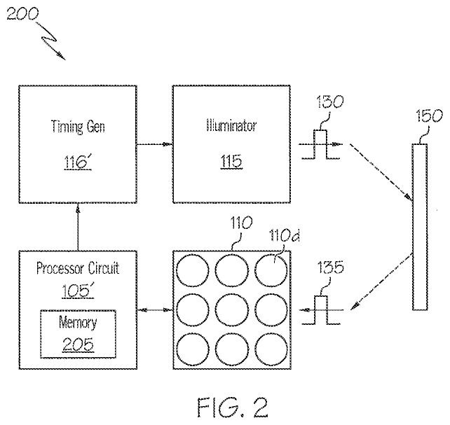

FIG. 2 further illustrates components of a ToF measurement system or circuit 200 in a LIDAR application in accordance with some embodiments described herein. The circuit 200 may include a processor circuit 105′ (such as a digital signal processor (DSP)), a timing generator 116′ which controls timing of the illumination source (illustrated by way of example with reference to a laser emitter array 115), and an array of single-photon detectors (illustrated by way of example with reference to a single-photon detector array 110). The processor circuit 105′ may also include a sequencer circuit that is configured to coordinate operation of the emitters 115e and detectors 110d.

The processor circuit 105′ and the timing generator 116′ may implement some of the operations of the control circuit 105 and the driver circuit 116 of FIG. 1. The laser emitter array 115 emits a laser pulse 130 at a time controlled by the timing generator 116′. Light from the laser pulse 130 is reflected back from a target (illustrated by way of example as object 150) as a return signal 135, which is sensed by single-photon detector array 110. The processor circuit 105′ implements a pixel processor that measures the ToF of the laser pulse 130 and its reflected signal 135 over the journey from emitter array 115 to object 150 and back to the single-photon detector array 110.

The processor circuit 105′ may provide analog and/or digital implementations of logic circuits that provide the necessary timing signals (such as quenching and gating or strobe signals) to control operation of the single-photon detectors 110d of the array 110 and process the detection signals output therefrom. For example, the single-photon detectors 110d of the array 110 may generate detection signals in response to incident photons only during the short gating intervals or strobe windows that are defined by the strobe signals. Photons that are incident outside the strobe windows have no effect on the outputs of the single photon detectors.

Detection events may be identified by the processor circuit 105′ based on one or more photon counts indicated by the detection signals output from the detector array 110, which may be stored in the memory 205. More generally, the processor circuit 105′ may include one or more circuits that are configured to generate the respective detector control signals that control the timing and/or durations of activation of the detectors 110d, and/or to generate respective emitter control signals that control the output of optical signals from the emitters 115e. In embodiments described herein, a global clock signal (Clk) may be generated and used to control the timing of the output of the optical signals (Laser Pulse) from the emitters and the quench signals (SPADRst) to reset the detectors 110d.

The processor circuit 105′ may be small enough to allow for three-dimensionally stacked implementations, e.g., with the detector array 110 “stacked” on top of the processor circuit 105′ (and/or other related circuits, such as the memory 205) that is/are sized to fit within an area or footprint of the array 110. For example, some embodiments may implement the detector array 110 on a first substrate, and transistor arrays of the circuits 105/105′ on a second substrate, with the first and second substrates/wafers bonded in a stacked arrangement, as described for example in U.S. patent application Ser. No. 16/668,271 entitled “High Quantum Efficiency Geiger-Mode Avalanche Diodes Including High Sensitivity Photon Mixing Structures and Arrays Thereof,” filed Oct. 30, 2019, the disclosure of which is incorporated by reference herein.

The pixel processor implemented by the processor circuit 105′ is configured to calculate an estimate of the average ToF aggregated over thousands of laser pulses 130 and photon returns in reflected light 135. The processor circuit 105′ may be configured to count incident photons in the reflected light 135 to identify detection events (e.g., based on one or more SPADs that have been triggered) over a laser cycle (or portion thereof). The timings and durations of the detection windows may be controlled by a strobe signal, many repetitions of which are aggregated (e.g., in the pixel) to define a sub-frame, with one or multiple sub-frames defining an image frame. Each sub-frame may correspond to a respective distance sub-range of the overall imaging distance range, where the frequency of the laser cycle may be selected based on the desired imaging distance range.

In some embodiments, a detector pixel may include one or more detectors 110d (e.g., SPADs 410d), circuits that implement a memory array (e.g., memory 205), and a memory controller (e.g., control circuit 105/processor 105′) such as a DRAM controller, collectively referred to herein as a memory circuit. In some embodiments, the DRAM controller may be implemented with simplified or minimal circuitry, for example, using a XOR-based LFSR feedback loop, precharge transistors, and two NOR gates per word, as described in further embodiment herein.

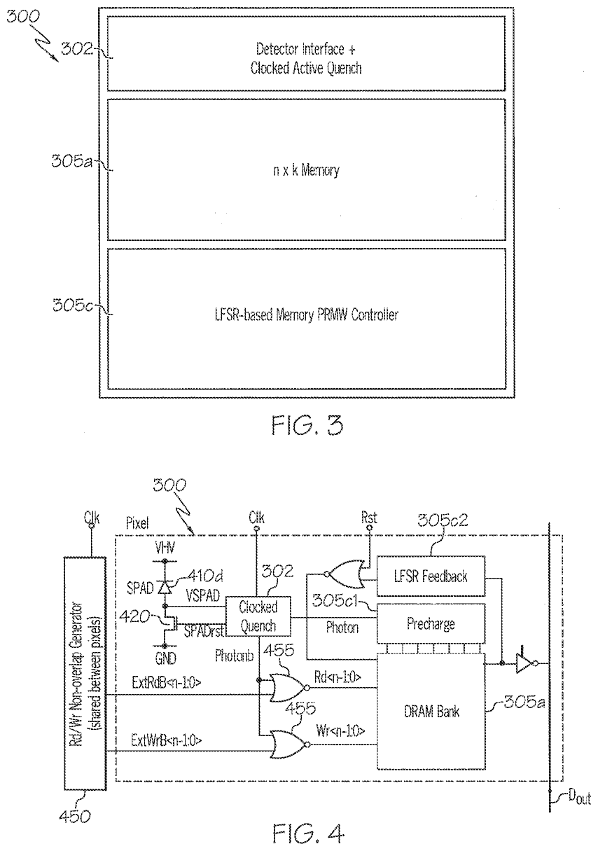

FIGS. 3 and 4 illustrate an example configuration of a memory circuit implementing a DRAM-based pixel 300 in accordance with some embodiments of the present disclosure. In particular, the DRAM-based pixel 300 of FIG. 3 may represent a lower or bottom tier of a pixel layout, for example, on which an array 110 of detector pixels may be stacked to define a three-dimensionally stacked implementation. The DRAM-based pixel 300 of FIG. 3 may thus be sized to fit within the area or footprint of the detector array 110.

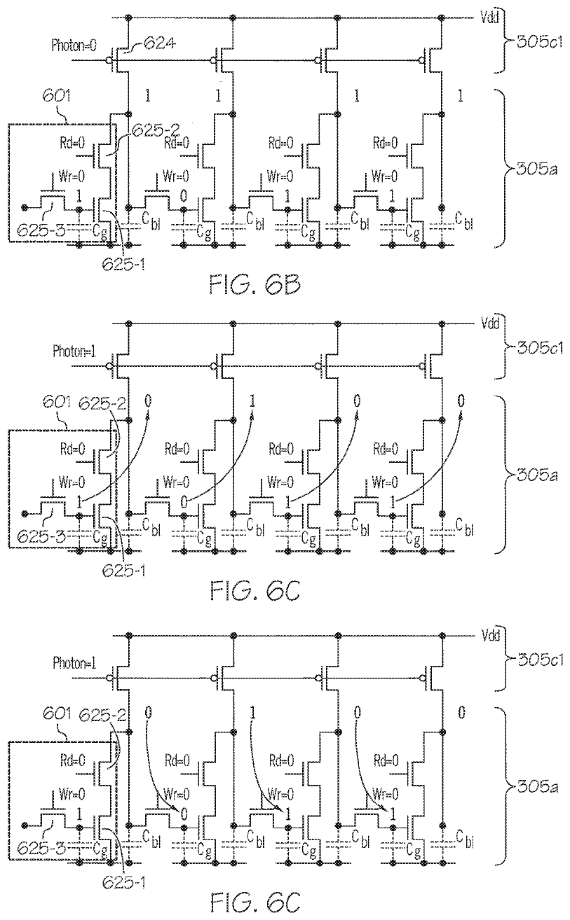

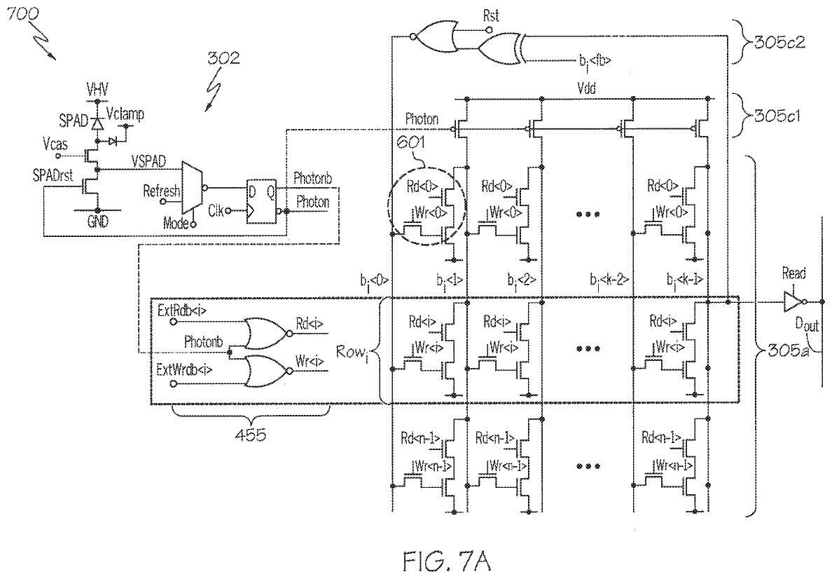

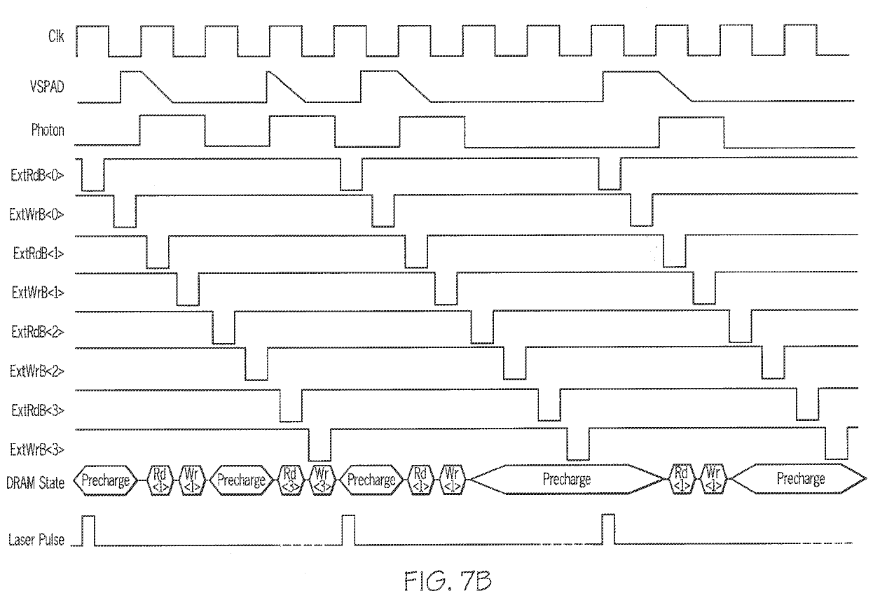

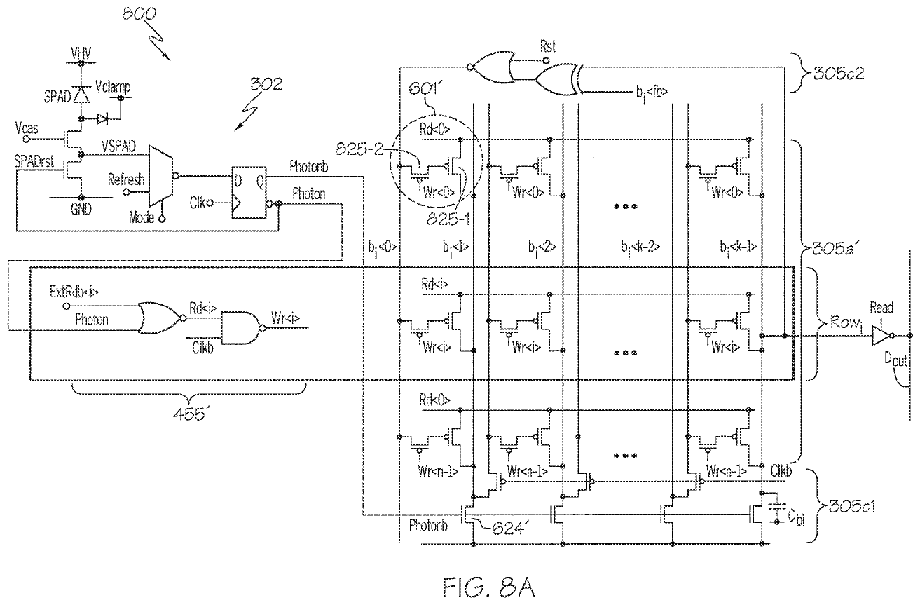

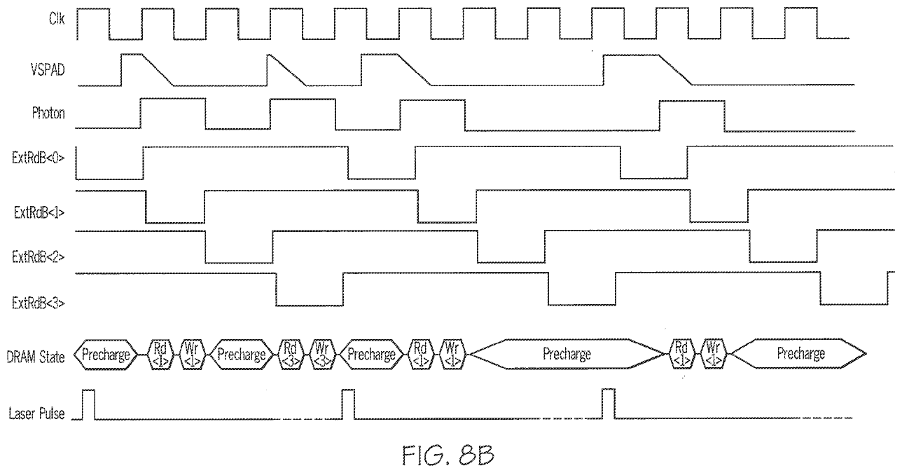

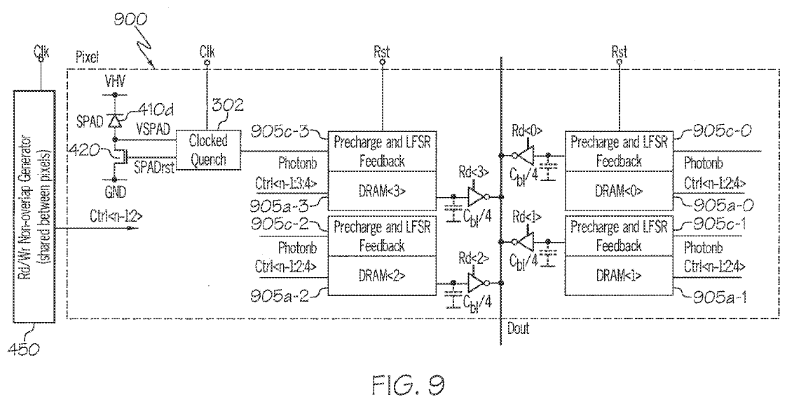

The DRAM-based pixel 300 of FIGS. 3 and 4 includes a photodetector interface circuit 302 configured to receive detection signals from one or more photodetectors (illustrated as SPAD interfaces). The photodetector interface circuit 302 may include a clocked active quench circuit that is operated responsive to a clock signal (Clk) to sample the detection signals output from the photodetectors 110d and quench or reset the photodetectors 110d (as described in greater detail below with reference to the SPADs 410d of FIGS. 5A and 5B). A read/write (Rd/Wr) non-overlap generator 450, which may be shared by multiple pixels so as to reduce area overhead per pixel, is also operated responsive to the clock signal (Clk) to provide read (Rd) or write (Wr) signals to the main memory device 305a (illustrated as a n×k bit DRAM bank or memory array). The DRAM bank 305a is configured to store photon counts and/or histogram data (where n refers to the number of histogram bins and k refers to the bits per bin), as described in greater detail below with reference to FIGS. 6A to 6D. A memory control circuit or memory controller 305c (illustrated as a DRAM PRMW controller, which includes a precharge circuit 305c1 and a LFSR feedback circuit 305c2) is configured to manage operations of the main memory device 305a (e.g., the DRAM bank) to store data indicated by the detection signals output from the photodetectors into the DRAM bank 305a (as described in greater detail below with reference to FIGS. 7A, 7B, 8A, and 8B), using sequential memory access operations that are coordinated with the clock-driven active quench operations described herein. The memory controller 305c may be effectively considered as a PRW controller, as the modify (M) operation can be implemented as a hardwired shift (represented in the connection pattern of the DRAM), such that no logic or circuitry external to the DRAM may be required to modify the data.

The refresh rate of the DRAM cells is also controlled by the memory controller 305c. In some embodiments, the refresh rate is selected such that memory refresh operations for all DRAM cells in the memory array 305a can be completed within the time (or period T) between emitter signal pulses (e.g., laser pulses). The time between laser pulses (which defines a laser cycle, or more generally emitter pulse frequency) may be selected or may otherwise correspond to a desired imaging distance range for the lidar system. In some embodiments, the refresh rate may be some integer multiple R of the laser frequency or rep rate, where for 1 in R laser cycles, the system may read, modify, and write all bins, and in the other R-1 cycles the system would read, modify, and write bins only if there was a photon detected.

In embodiments described herein, a refresh operation may be achieved by using a multiplexer in the clocked active quench circuit 302 (e.g., MODE=0 or Photon=0, pulse on Refresh) to force an increment of the memory cells for each of the n memory bins. This can be a deterministic increment which may require a relatively small value in terms of the dynamic range of the memory bins available for photon counting. However, this value is known and can be subtracted from the memory values. Retention times of a few milliseconds (ms) may be expected, which may allow fewer than 10 refresh cycles in a 10 ms full exposure occupying only 4 bits of the memory bin width k, which can be over 16 bits. This may be a simpler operation than using external circuitry to change the direction of LFSR data shift during a refresh operation.

An example implementation of the clocked active quench circuit 302 of FIGS. 3 and 4 is shown in the schematic block diagram of FIG. 5A. The clocked active quench circuit 302 includes a sampling circuit 502 and a reset circuit 420. In particular, the clocked active quench circuit 302 provides a photodetector control circuit that couples the detection signal (VSPAD) output from a photodetector (e.g., a SPAD 410d) to a sampling circuit 502 (e.g., a latch or flip-flop, illustrated as an edge triggered D flip-flop) that is operated responsive to the global clock signal (Clk) to sample the detection signal (Photon) and provide a quench signal (SPADRst, which may be or may be based on the sampled detection signal) to a reset circuit 420 (e.g., a reset transistor) that resets the photodetector 410d on the next or immediately following clock (Clk) transition. A bias circuit 520 (e.g., a higher voltage transistor in a cascode arrangement) is provided between the output of the SPAD 410d and the reset circuit 420 (e.g., the lower voltage reset transistor), such that no level shift electronics are needed.

As shown in the timing diagram of FIG. 5B with reference to the block diagram of FIG. 5A, in response to detection of a photon by the SPAD 410d, the SPAD output/detection signal (VSPAD) has a ‘high’ state, resulting in a ‘high’ state for the sampled detection signal (Photon) that is output from the clocked active quench circuit 302 upon the next transition of the clock signal (Clk) from a ‘low’ state to a ‘high’ state. The transition of the clock signal (Clk) also results in providing the ‘high’ state sampled detection signal (Photon) to the reset transistor 420 as the quench signal (SPADRst), which quenches or resets the SPAD 410d, without the need for delay logic. As such, power is consumed only on transition of the clock signal (Clk), with a maximum of one SPAD quench or reset per clock cycle.

The clocked active quench circuit 302 of FIG. 5A is relatively compact, and may be smaller than some conventional active quench circuits by about 10 times or more. The pulse width of the sampled detection signal (Photon) may correspond to one period or cycle of the clock signal (Clk). The sampled detection signal (Photon) output from the clocked active quench circuit 302 may be provided to the precharge circuit 305c1, as shown in FIG. 4 and described in greater detail with reference to FIGS. 6B to 6D.

FIG. 6A illustrates an example memory device implementing the n×k bit DRAM Bank 305a of FIGS. 3 and 4 using 3T DRAM cells. As shown in FIG. 6A, each memory cell 601 (0 to k−1) of the rows (0 to n−1) includes three transistors 625-1, 625-2, 625-3 (collectively 625; illustrated as NMOS transistors). In the examples described herein, each row (Row 0 to Row n−1) of memory cells 601 may correspond to a respective histogram time bin, and may also be referred to herein as a memory bin. First (lower) and second (upper) transistors 625-1 and 625-2 of each memory cell 601 are series-connected to a respective bit line bᵢ<1: k−1>, and a third transistor 625-3 is connected between the bit line bᵢ<0: k−2> and a gate of the first transistor 625-1. The first transistor 625-1 acts as a storage element or storage node for the memory cell. A read signal Rd<0: n−1> provides a control signal to the gate of the second transistor 625-2 in a read operation, and a write signal Wr<0: n−1> provides a control signal to the gate of the third transistor 625-3 in a write operation. The memory device 305a may be accessed sequentially, e.g., by stepping progressively through and updating memory bins in real time with incoming photon counts returning from the laser pulse reflected from a target responsive to continuously or periodically applying a control signal to an emitter unit and applying a strobe signal to a detector pixel to cycle through a series of distance sub-ranges.

FIGS. 6B, 6C, and 6D are enlarged views illustrating operation of an example implementation of a precharge circuit 305c1 and a row of the memory device 305a of FIG. 6A during precharge, read, and write cycles, respectively. As shown in FIG. 6B, when no photons are detected, the sampled detection signal (Photon) output from the clocked active quench circuit of FIG. 5A has a ‘low’ state (logic ‘0’; Photon=0), which is provided to the precharge circuit 305c1, and activates precharge transistors 624 to precharge the bitlines at the ‘high’ state (logic ‘1’; corresponding to Vdd in this example). The state of each DRAM cell 601 is held based on the parasitic capacitance C_{g} of the storage node transistor 625-1. As shown, the DRAM cells 601 are directly connected (or chained) without the use of sense amplifiers.

As shown in FIG. 6C, when data is to be read from the cells 601 of a memory bin, read signal Rd<0: n−1> is asserted (Rd=1) and data is read through the corresponding bit lines bᵢ<1: k−1>. More particularly, for an increment operation, the sampled detection signal (Photon) output from the clocked active quench circuit of FIG. 5A has a ‘high’ state (Photon=1), which is provided to the precharge circuit 305c1 to interrupt the precharge state. The held state of each memory cell 601 (based on the parasitic capacitance C_{g} of each storage node transistor 625-1) is amplified, inverted and “written” onto the bit lines bᵢ<1: k−1> to be read out (illustrated by the arrows in FIG. 6C).

As shown in FIG. 6D, when data is to be written to the memory cells 601, write signal Wr<0: n−1> is asserted (Wr=1), and the data from the bit lines bᵢ<0: k−2> are stored in the storage node/first transistor 625-1 of an adjacent DRAM cell 601. More particularly, for an increment operation, the sampled detection signal (Photon) output from the clocked active quench circuit of FIG. 5A has a ‘high’ state (Photon=1), which is provided to the precharge circuit 305c1 to interrupt the precharge state. The write signal Wr<0: n−1> is applied to the gate of the third/write transistor 625-3, which shorts or connects the bit lines bᵢ<0: k−2> to the storage node/first transistor 625-1 of an adjacent DRAM cell 601, such that the data from the bit lines bᵢ<0: k−2> (which have a higher capacitance, Cbl) are stored in the storage node/first transistor 625-1 of an adjacent DRAM cell 601 (which has a lower capacitance, Cg). That is, because Cbl is much greater than Cg, the charge sharing overwrites the held state of the storage node transistor 625-1 of each memory cell 601 with the charge on the bit line connected thereto (illustrated by the arrows in FIG. 6D). In particular, if Cg is low the bit line is not discharged and remains high, while if Cg is high the bit line is discharged and so transitions low. Data is thus shifted forward and inverted (from the gate input of the storage node 625-1 to the bit line) by dynamic charge sharing by parasitics, without shoot through current. More particularly, as the precharge transistors 624 are off when the read transistors 625-2 are on, no current flows from Vdd directly to ground, and only parasitic capacitances are discharged (or not discharged, depending on the memory state). The logic state of each memory cell 601 can be maintained through cyclical refresh operations (responsive to signal Refresh shown in FIG. 5A) until a new increment operation is initiated. In some embodiments of clocked DRAM pixels described herein, the power required to increment a histogram bin may be reduced to about 10% or less of the SPAD energy per photon.

Each of the increment and refresh operations for the DRAM-based pixels described herein may include a precharge-read-modify-write (PRMW) operation, in which the current contents of a given memory bin 0 to n−1 is read, incremented (responsive to the presence of detection events) or refreshed (responsive to the absence of detection events), and written back to the respective memory bin. The retention time of the voltage on the storage node can determine a maximum refresh period required to maintain a stored logic state for each DRAM cell. In some embodiments, the time to complete a refresh operation may be such that each DRAM cell of the memory array may be refreshed in the time between pulses of the lidar emitter signal; however, the period or frequency of performing the refresh operations may be dependent on the leakage (also referred to herein with reference to retention time) of the DRAM cells, which can vary with temperature. As such, it will be understood that refresh operations may be performed more or less frequently, or otherwise as needed to meet the leakage requirements of the DRAM cells under the operating conditions.

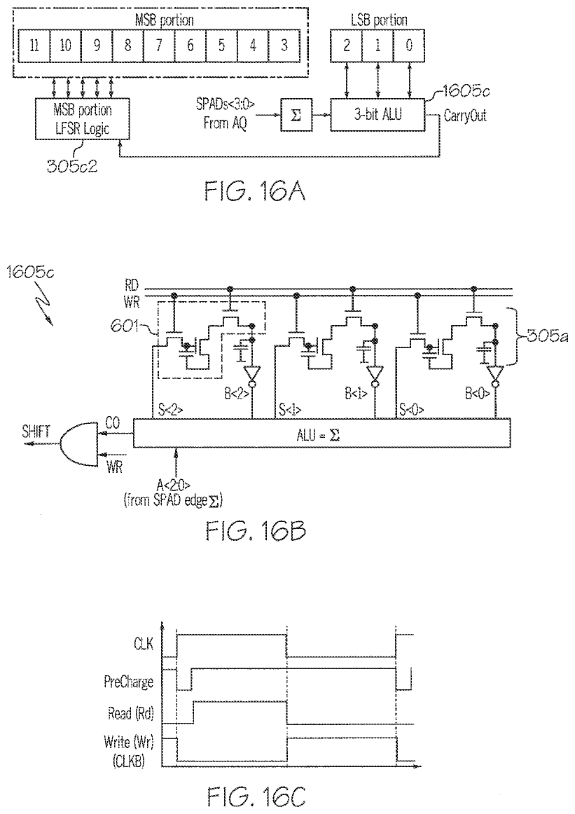

FIG. 7A illustrates an example circuit 700 that is configured to perform increment and refresh operations according to some embodiments of the present disclosure. FIG. 7B is a timing diagram illustrating the states of the signals shown in FIG. 7A. In particular, FIG. 7A illustrates an example embodiment including the clocked active quench circuit 302 of FIG. 5A, a precharge circuit 305c1, and a k-bit linear feedback shift register (LFSR) PRMW logic circuit 305c2 that is configured to perform increment operations for an example row or bin (highlighted as Row i) of the 3T (NMOS) DRAM array 305a of FIG. 6A, responsive to the presence of a detection event during a window of activation of a detector pixel in an emitter cycle (e.g., during the time between emitter signal pulses, illustrated as Laser Pulse in FIG. 7B). An LFSR 305c2 is a shift register whose input bit is a linear function of its previous state. LFSR-based counting (rather than an ALU-based counting) can be used to reduce or minimize memory bin update times (and hence improve time resolution), as well as to reduce or minimize precharge-read-modify-write (PRMW) logic overhead. However, it will be understood that embodiments of the present disclosure are not so limited, and may include combinations of LFSR-based counting and ALU-based counting (e.g., with the ALU for counting less-significant bits and the LFSR for counting more significant bits, as shown in FIG. 16A), and/or other logic circuits to implement increment and refresh operations as described herein.

As shown in FIG. 7A, in an increment operation, the sampled detection signal (Photon) output from the clocked active quench circuit 302 has a ‘high’ state responsive to a detection event, and bits stored in the DRAM cell 601 of a memory bin (highlighted as bin i) are shifted forward by one using LFSR loop feedback 305c2 (implemented in this example by XOR and NOR logic gates). A maximum-length LFSR may require a number of bits to be fed-back to the input via XNOR operations. Which bits are to be fed back may depend on the number of bits per bin k. In the circuit 700 of FIG. 7A, the bit index is represented by fb, which refers to the specific case of two bits being fed back (i.e., k and some other bit fb). The number of bits per bin k may be selected to reduce the required logic (which can otherwise increase overhead, e.g., for k values with more than two feedback bits). In the circuit 700 of FIG. 7A, an input bit to the leftmost 3T DRAM cell 601 (e.g., the least significant bit of bin i) is driven by the values on the bit line bᵢ<fb> and the value on the most significant bit line bᵢ<k−1>. The value stored in each 3T DRAM cell 601 is thereby shifted to the 3T DRAM cell 601 on its right.

More particularly, as shown in FIGS. 7A and 7B, in response to detection of a photon by the SPAD, the SPAD output/detection signal (VSPAD) has a ‘high’ state, resulting in a ‘high’ state for the sampled detection signal (Photon) upon the next transition of the clock signal (Clk) from a ‘low’ state to a ‘high’ state (which is also provided as the reset or recharge signal SPADRst to quench and recharge the SPAD). The inverted sampled detection signal (Photonb) is provided to read/write logic 455 (implemented in this example by parallel NOR gates), which is also responsive to sequential read and write enable signals ExtRdB<0: n−1> and ExtWrB<0: n−1> to output the read and write signals Rd<0: n−1> and Wr<0: n−1>, resulting in transitions of the memory state (DRAM state) between precharge, read, and write cycles, as described with reference to FIGS. 6B, 6C, and 6D.

FIG. 8A illustrates another example circuit 800 that is configured to perform increment and refresh operations according to some embodiments of the present disclosure. FIG. 8B is a timing diagram illustrating the states of the signals shown in FIG. 8A. In particular, FIG. 8A illustrates an example embodiment including the clocked active quench circuit 302 of FIG. 5A, a precharge circuit 305c1, and a k-bit linear feedback shift register (LFSR) PRMW logic circuit 305c2 that is configured to perform increment operations for an example row or bin (highlighted as Row i) of a memory device 305a′ (implemented in this example by a 2T (PMOS) DRAM array), responsive to the presence of a detection event during a window of activation of a detector pixel in an emitter cycle (e.g., during the time between emitter signal pulses Laser Pulse in FIG. 8B).

In the DRAM array of FIG. 8A, each memory cell 601′ (0 to k−1) of the rows (0 to n−1) includes two transistors 825-1, 825-2 (collectively 825; illustrated as PMOS transistors), where each row of memory cells may correspond to a respective histogram time bin or memory bin. A first transistor 825-1 of each memory cell 601′ is series-connected to bit line bᵢ<1: k−1>, and a second transistor 825-2 is selectively connected between the bit line bᵢ<0: k−2> and a gate of the first transistor 825-1 in response to the inverted clock signal Clkb. The first transistor 825-1 acts as a storage node for the memory cell 601′. A read signal Rd<0: n−1> provides a control signal to the source of the first transistor 825-1 in a read operation. A write signal Wr<0: n−1> provides a control signal to the gate of the second transistor 825-2 in a write operation, which (responsive to the inverted clock signal Clkb) shorts or connects the bit lines bᵢ<0: k−2> to the storage node/first transistor 825-1 of an adjacent DRAM cell 601′, such that the data from the bit lines bᵢ<0: k−2> are stored in the storage node/first transistor 825-1 of an adjacent DRAM cell 601′ via charge sharing, as similarly discussed above with reference to the 3T DRAM implementation of FIG. 7A. The memory device 305a′ of FIG. 8A may likewise be accessed sequentially, e.g., by stepping progressively through and updating memory bins.

As shown in FIG. 8A, in an increment operation, the sampled detection signal (Photon) output from the clocked active quench circuit 302 has a ‘high’ state responsive to a detection event, and bits stored in the DRAM cell 601′ of a memory bin (highlighted as bin i) are shifted forward by one using LFSR loop feedback 305c2 (again, implemented by XOR and NOR logic gates). An input bit to the leftmost 2T DRAM cell 601′ (e.g., the least significant bit of bin i) is driven by the values on the bit line bᵢ<fb> and the value on the most significant bit line bᵢ<k−1>, and the value stored in each 2T DRAM cell 601′ is thereby shifted to the 2T DRAM cell 601′ on its right.

More particularly, as shown in FIGS. 8A and 8B, in response to detection of a photon by the SPAD, the SPAD output/detection signal (VSPAD) has a ‘high’ state, resulting in a ‘high’ state for the sampled detection signal (Photon) upon the next transition of the clock signal (Clk) from a ‘low’ state to a ‘high’ state (which also resets the SPAD), in a manner similar to that described with reference to FIG. 7A. The inverted sampled detection signal (Photonb) is provided to the precharge transistors 624′ of the precharge circuit 305c1, interrupting the precharge state. The sampled detection signal (Photon) is also provided to read/write logic 455′ (implemented in this example by sequential NOR and NAND gates), which is also responsive to sequential read enable signals (ExtRdB<0: n−1>) to output the read or write signals (Rd<0: n−1> or Wr<0: n−1>) in response to the inverted clock signal (Clkb), resulting in transitions of the memory (DRAM state) between precharge, read, and write cycles, in a manner similar to that described with reference to FIGS. 6B, 6C, and 6D.

In the examples of FIGS. 7A-7B and 8A-8B, each bin (0: n−1) may be accessed serially (i.e., one bin at a time) based on the sequential read enable signals (ExtRdB<0: n−1>) (in FIGS. 8A-8B) and the sequential read enable signals (ExtRdB<0: n−1>) and write enable signals (ExtWrB<0: n−1>) (in FIGS. 7A-7B) during the time between the optical signals Laser Pulse, but not necessarily in any particular order. That is, for each strobe cycle j (e.g., cycles or repetitions of a strobe window for a particular distance subrange), and for bin i=0 to n−1 (in a sequence), if a detection event (e.g., an incident photon) is identified or present in cycle j, then the value stored in the appropriate bin i (corresponding to the time of arrival during the strobe window) is incremented. If a detection event is not identified or absent in cycle j, the value stored in bin i may be either refreshed (for higher refresh rates) or no action may be taken for that cycle j (for lower refresh rates). In some embodiments, the increment or refresh operations can be performed sequentially for each row/bin 0 to n−1, with readout Dout (responsive to a readout signal Read) in a rolling-shutter scheme.

In some embodiments, the memory may be gain cell-based memory (e.g., gain cell-eDRAM). Example gain cell-eDRAM (GC-eDRAM) transistor arrangements that may be used in memory cell arrays in accordance with embodiments of the present disclosure may be as described in Meinerzhagen et al., “Gain-Cell Embedded DRAMs for Low-Power VLSI,” Springer International Publishing AG (2018). These transistor arrangements are provided by way of example only, and embodiments of the present disclosure are not limited thereto. The use of gain cell DRAM may require fewer transistors per pixel (e.g., 1-3 transistors) of a same type (e.g., NMOS-only, or PMOS-only) as compared to SRAM implementations, with memory refresh operations performed that may be at a sufficient refresh rate (e.g., once per emitter signal cycle, once every two emitter signal cycles, etc.) to prevent leakage of the stored value in each DRAM cell, and may be completed within the time between pulses of a lidar emitter signal. In some embodiments, the state of the DRAM cell may be held on its own parasitic capacitance (e.g., the parasitic capacitance of its storage node transistor).

Some embodiments may include two transistor (2T) and/or three transistor (3T) DRAM configurations, where the DRAM cells of each memory bin can be incremented in response to a detection event, or can be refreshed periodically and/or in the absence of detection events, during the time between pulses of the emitter signal. For example, for a 200 meter (m) imaging distance range, an emitter cycle may have a frequency of 750 kHz, with a period of about 1.33 μs between pulses of the emitter signal. The maximum refresh time for a memory bin in this example may correspond to the 1.33 μs emitter cycle, which may be sufficient to overcome bit leakage issues (e.g., at temperatures of about 125° C. or more).

FIG. 9 is a schematic diagram illustrating folding and partitioning configurations that are configured to reduce bit line capacitance according to some embodiments of the present disclosure. As shown in FIG. 9, a DRAM-based pixel 900 in accordance with some embodiments of the present disclosure may be similar to the pixel 300 of FIGS. 3 and 4, but with the memory block 305a and the memory controller 305c partitioned into multiple memory partitions 905a-0, 905a-1, 905a-2, 905a-3 (shown as four memory partitions, DRAM <0: 3>) and multiple associated controller circuits 905c-0, 905c-1, 905c-2, 905c-3 to provide more manageable layout and bit line capacitance.

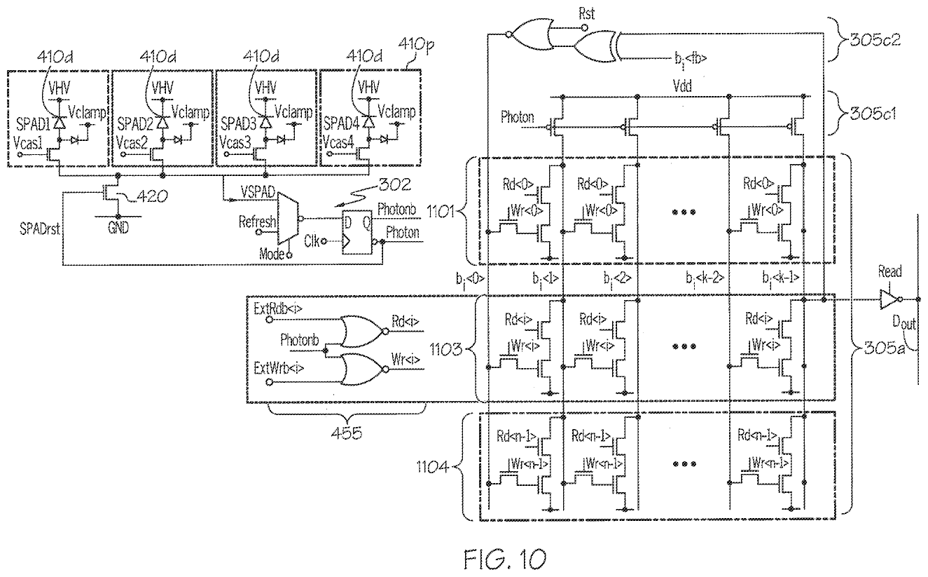

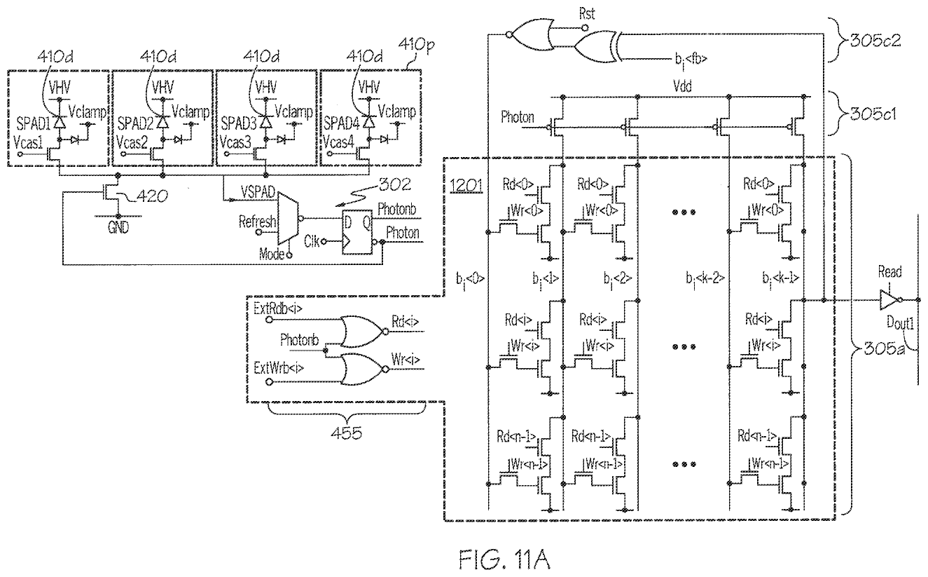

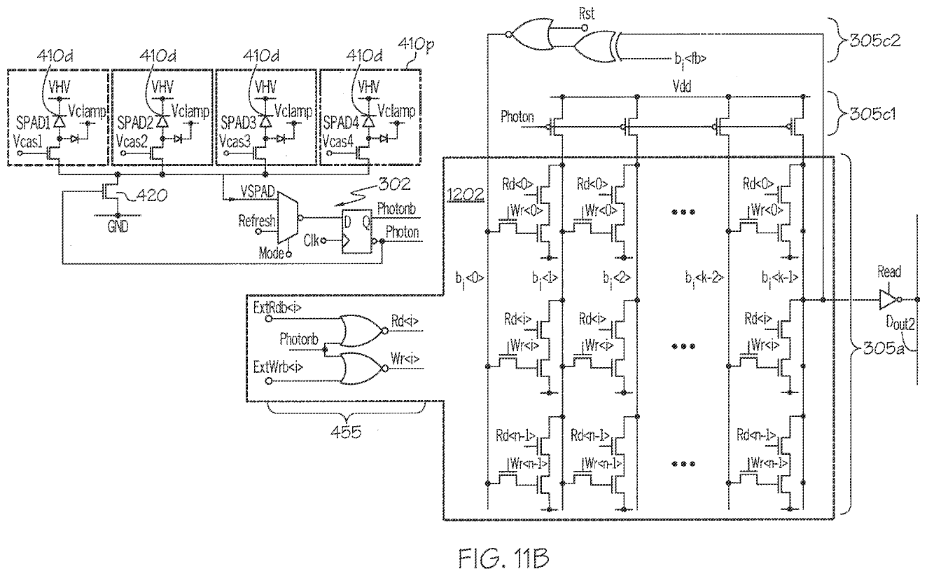

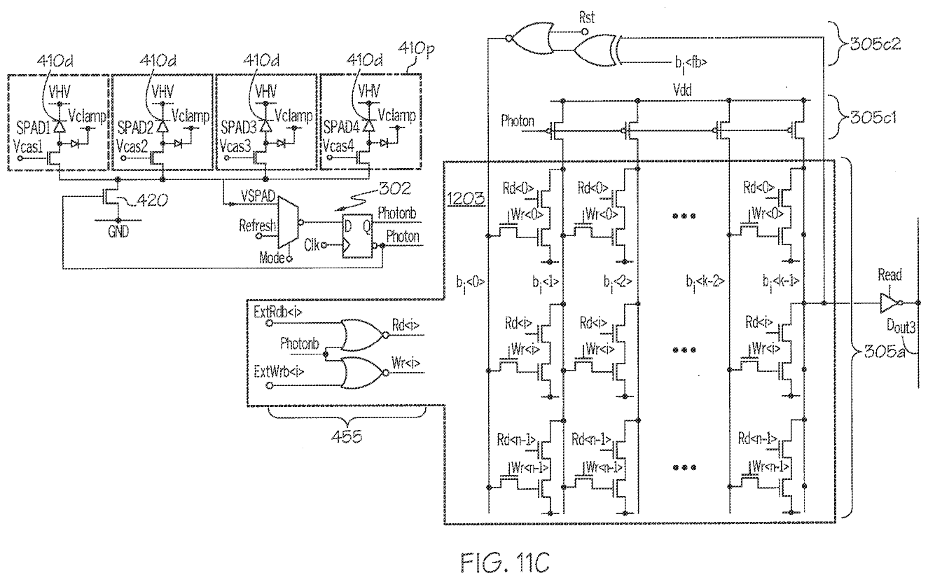

FIGS. 10-15 are schematic circuit diagrams illustrating example memory usage schemes according to some embodiments of the present disclosure. FIGS. 10-15 are illustrated with references to detector arrays including 4 detectors 410d (shown as SPADs) per pixel 410p, but it will be understood that fewer or more detectors per pixel may be included in some embodiments. In FIGS. 10-13, the pixel logic 455 around the memory 305a is shared between the SPADs 410d, and the entire array of SPADs 410d of each pixel 410p is reset (responsive to reset signal SPADRst) upon the next clock cycle after a detection event.

FIG. 10 illustrates an example implementation of a 4×1 detector array that share respective sub-regions of a DRAM array 305a. As shown in FIG. 10, photons detected by each detector SPAD1-SPAD4 of the 4×1 detector array are stored in a respective row or bin 1101-1104 of the DRAM array. That is, the outputs of the detectors 410d (SPAD1, SPAD2, SPAD3, and SPAD4) in a pixel 410p are multiplexed one at a time (e.g., by asserting one of the control voltages Vcas1, Vcas2, Vcas3, and Vcas4, respectively), and each detector 410d (SPAD1, SPAD2, SPAD3, and SPAD4) has a dedicated counting memory (corresponding to rows 1101, 1102 (not shown), 1103, and 1104, respectively, of DRAM array 305a), which is incremented responsive to each detection event. The example of FIG. 10 is not limited to histogram data storage, and may be used for high resolution photon counting.

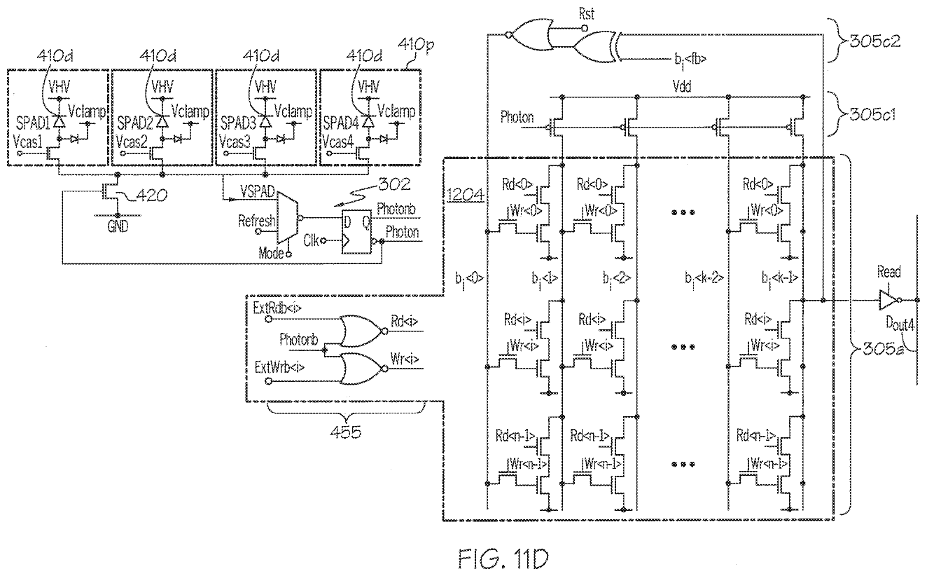

FIGS. 11A-11D illustrates an example implementation of a 4×1 detector array that share the entire DRAM array 305a. In FIGS. 11A-11D, the detectors 410d (SPAD1, SPAD2, SPAD3, and SPAD4) are multiplexed to be active or enabled one at a time (in sequential access operations 1201, 1202, 1203, and 1204, respectively), and the enabled detector 410d (SPAD1 in FIG. 11A, SPAD2 in FIG. 11B, SPAD3 in FIG. 11C, and SPAD4 in FIG. 11D) is used to build and store a histogram in-pixel, with the multiplexing controlled by asserting one of the control voltages Vcas1, Vcas2, Vcas3, and Vcas4, respectively. Once the histogram data detected by the enabled detector 410d (e.g., SPAD1 in FIG. 11A) and stored in the memory 305a is read out (as signal Dout1), the next detector 410d (e.g., SPAD2, in FIG. 11B) is used to build and store a new histogram in the memory 305a, which is read out (as signal Dout2), then the next detector 410d (e.g., SPAD3 in FIG. 11C) is used to build and store a new histogram in the memory 305a, which is read out (as signal Dout3), and then the next detector 410d (e.g., SPAD4 in FIG. 11D) is used to build and store a new histogram in the memory 305a, which is read out (as signal Dout4). In the example of FIGS. 11A-11D with four SPADs 410d per pixel 410p, four sequential access operations may be required to collect histograms for the full spatial resolution of the sensor.

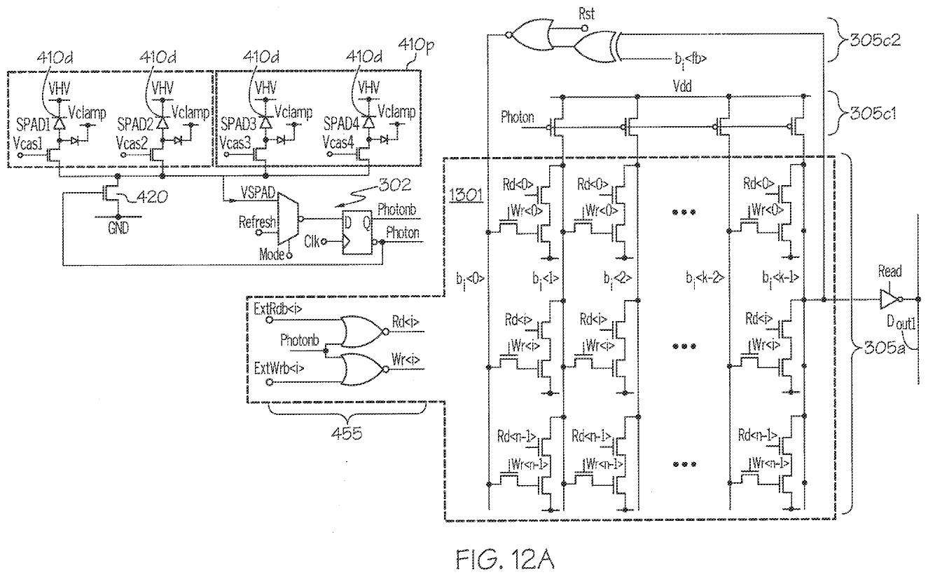

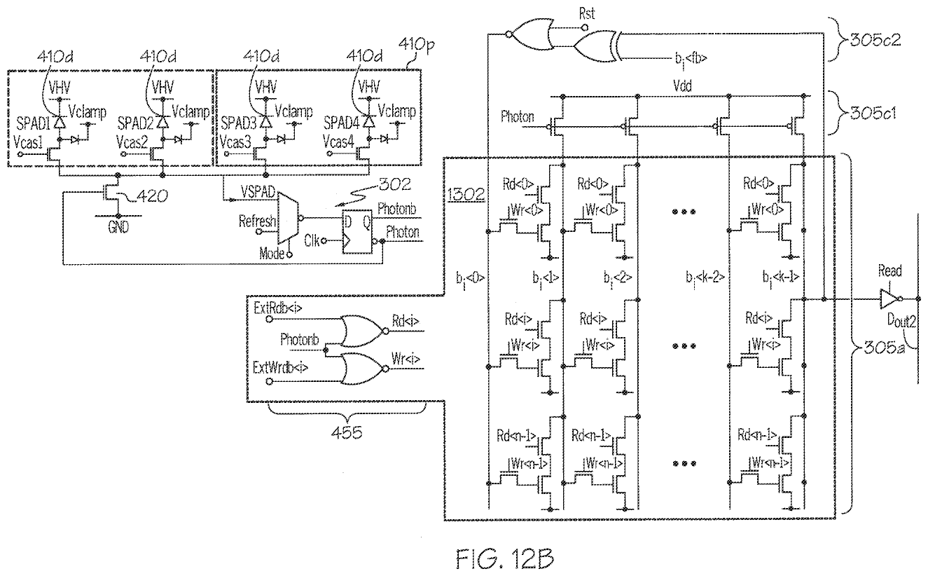

FIGS. 12A-12B illustrates an example implementation of a 2×2 detector array that share the entire DRAM array 305a. The operations of FIGS. 12A-12B are similar to FIGS. 11A-11D, but two detectors 410d are active or enabled at a time (e.g., SPAD1 and SPAD2 in access operation 1301 of FIG. 12A; or SPAD 3 and SPAD4 in access operation 1302 of FIG. 12B). Whichever one of the pair of enabled detectors 410d (SPAD1 or SPAD2) detects a photon first provides a detection signal that is stored as histogram data in the memory 305a, and once the histogram data detected by the enabled detector pair (e.g., SPAD1 and SPAD2 in FIG. 12A) is read out (as signal Dout1) in access operation 1301, the next detector pair (e.g., SPA3 and SPAD 4 in FIG. 12B) is enabled. Whichever one of the pair of enabled detectors 410d (SPAD3 or SPAD4) is first to detect a photon provides a detection signal that is stored as a new histogram in the memory 305a and is read out (as signal Dout2) in access operation 1302. As compared to the example of FIGS. 11A-11D, the example of FIGS. 12A-12B provides half the spatial resolution but twice the effective frame rate of the sensor, with the multiplexing controlled by asserting pairs of control voltages (Vcas1 and Vcas2) or (Vcas3 and Vcas4) at a time.

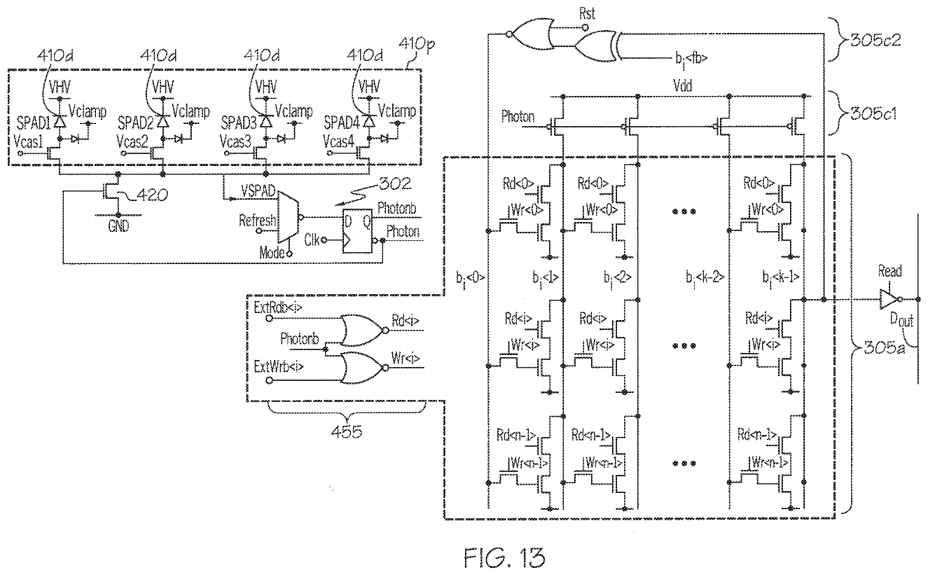

FIG. 13 illustrates another example implementation of a detector array that the shares the entire DRAM array 305a. As shown in FIG. 13, all of the detectors 410d (SPAD1, SPAD2, SPAD3, and SPAD4) of a pixel 410p of the array are active or enabled simultaneously, and whichever is first to detect a photon contributes to the histogram data stored in the memory 305a. As compared to the example of FIG. 12A-12B, spatial resolution is further reduced, but effective frame rate is increased.

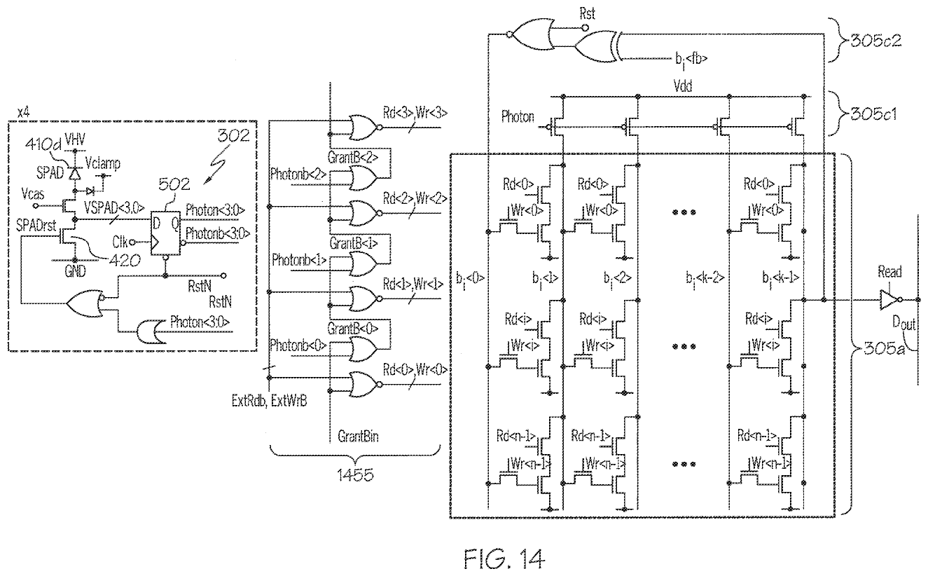

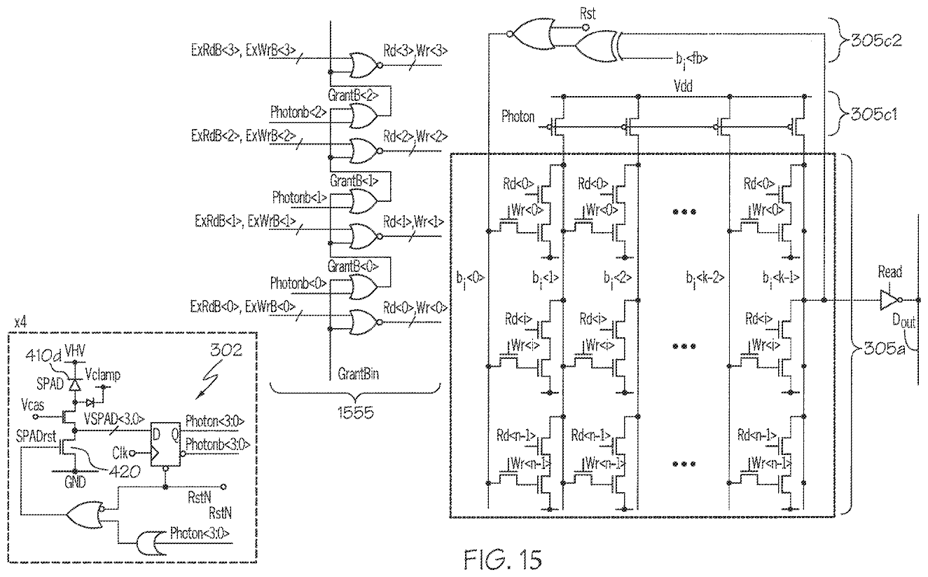

FIGS. 14 and 15 illustrates example implementations of a detector array that shares the full DRAM array 305a, using single phase and 4 phase arbitration schemes, respectively. In FIGS. 14 and 15, each detector 410d (SPAD) has its own active quench circuit 302, and all detectors 410d (shown by way of example with reference to four SPADs “×4”) are active or enabled at the same time, but an artbiter or arbitrar circuit 1455, 1555 is used to manage priority in accessing the DRAM array 305a.

In particular, in the example of FIG. 14, there are four DRAM memories, provided by respective rows of the DRAM array 305a, each corresponding to a respective detector 410d (SPAD; representing four detectors SPAD0-SPAD3). That is, the DRAM bank 305a may provide one DRAM row or word per SPAD 410d. A detection event by SPAD0 provides priority to SPAD0 to increment its DRAM word, else SPAD1 gets priority to increment its DRAM word, else SPAD2 to increment its DRAM word, else SPAD3 to increment its DRAM word. In case of simultaneous detection events or ‘firings’ by multiple detectors 410d (e.g., SPAD0 and SPAD1 detect photons at the same time), the detector 410d with the higher priority (in this example, SPAD0) increments its DRAM word in the memory 305a.

Similarly, in the example of FIG. 15, the respective detectors 410d (SPAD; representing four detectors SPAD0-SPAD3) have the same priority order for memory access as in FIG. 14. However, in FIG. 15, each DRAM memory row or word defines a histogram bin, rather than being allocated to a particular SPAD 410d. As such, if SPAD0 fires, it increments bin 0, 1, 2 or 3, based on which external phase signal (ExtRdB<3:0>, ExtWrB<3:0>) is active. Likewise, if SPAD1 fires, it increments bin 1, 2 or 3, based on which external phase signal is active; if SPAD2 fires, it increments bin 2 or 3, based on which external phase signal is active; and if SPAD3 fires it increments bin 3 based on which external phase signal is active.

In the implementations shown in FIGS. 14 and 15, non overlapping delay of the external phase write signals (ExtWrB<3:0>) and the external phase read signals (ExtRdB<3:0>) may eliminate glitches from GrantB OR chain settling of the arbiter 1455, 1555. The required area may be increased due to the logic requirements (e.g., 4×DFF and 3×OR2 and 1×OR4, 4 NMOS).

More generally, in the implementations shown in FIGS. 14 and 15, the pixel pitch may be reduced or minimized. For example, in some embodiments, the area per SPAD 410d may be that required for one front-end circuit, two NOR gates, one-quarter of the DRAM PRMW (XOR and NOR), and the area of DRAM bin, which may require only a few microns in some currently available stacked bottom tier digital logic processes.

Some embodiments may require increased LFSR decoder power in some regions (e.g., edge regions) of the memory array, but may provide reduced LFSR+DRAM power in other regions (e.g., in the central regions) of the memory array, which may allow for easier or more efficient power distribution. Embodiments described herein may be used to achieve pixel parameters (e.g., pixel pitch, on the order of micrometers) that may be used in various applications, for example (but not limited to) high dynamic range (HDR) multi-megapixel resolution direct or indirect time of flight image sensors. Also, even pixels with two to four bins (which may be conventionally used in iToF) can be used in strobed mode with power stepping or variation of emission power for different strobe windows (as described for example in U.S. Patent Application Publication No. 2020/0249318 entitled “Strobe Window Dependent Illumination for Flash LIDAR” to Henderson et al., the disclosure of which is incorporated by reference herein) to achieve dToF. Embodiments described herein may achieve pixel pitches of less than about 10 μm, for example, of between about 3 to 10 μm in some embodiments.

Embodiments using LFSR-based counting as discussed above may allow for relaxed bin timing, simplified operation, and reduced power. As discussed above, a DRAM pixel (e.g., 300, 900) using LFSR-based counting may be used with a single SPAD input per pixel 410p, e.g., where the increment operation is performed in response to the presence of a detection event by sequentially shifting data stored in a storage element (e.g., 625-1, 825-1) to a bit line of a succeeding memory cell 601 in a same row, and a refresh operation is performed in response to the absence of a detection event. However, problems may arise in implementations with multiple SPADs per pixel, as the LFSR 305c2 may not be shifted multiple times within the duration of a single bin in order to account for multiple or all SPAD firings, unless a more complex multiplexing scheme is used.

Further embodiments of the present disclosure may provide DRAM pixels using LFSR-based counting in combination with inputs from multiple SPADs per pixel by using partial ALU-based counting. For example, in some embodiments a partial ALU circuit may be used for counting lower or less significant bits (e.g., for the 3 least significant bits), allowing for faster settling response without significant power draw or area implications.

FIGS. 16A-16C illustrate an example implementation of a multi-SPAD detector pixel with LFSR-based counting using a partial ALU according to some embodiments of the present disclosure. As shown in FIG. 16A, an x-bit ALU circuit 1605c (where x is less than the number of detectors per pixel) is used in combination with LFSR-based counter circuit 305c2, where the ALU circuit 1605c is used to count lower significant bits, and the LFSR-based counter circuit 305c2 is used to count more significant bits. In the example of FIG. 16A, x=3 for detector pixels that include 4 SPADs per pixel.

FIG. 16B is an example circuit diagram illustrating the LSB portion of FIG. 16A, and FIG. 16C is an example timing diagram illustrating operation of the LFSR logic circuit 305c2 and ALU logic circuit 1605c of FIG. 16A. In the example of FIGS. 16A-16C, each bin includes 12 bits per bin, and may be implemented by DRAM cell configurations described herein. At the start of every bin (e.g., of about 4 ns), the 12 bits of the DRAM memory 305a are read out, the lower 3 bits into the ALU logic circuit 1605c and the higher 9 bits into the LFSR logic circuit 305c2. The ALU logic circuit 1605c adds previous lower 3-bit counts to new 3-bit SPAD sum. If the carry out signal (CO) is ‘high’, then the LFSR logic circuit 305c2 shifts the bits of the MSB portion by one. If the carry out signal (CO) is low, the LFSR logic circuit 305c2 refreshes the current bits of the MSB portion. Any remainder sum in the ALU logic circuit 1605c is written back into the LSB portion and is used in the next operation. This may also ensure that the LSB portion of the DRAM memory 305a is regularly refreshed.

As shown in the timing diagram of FIG. 16C, the precharge operation sets the DRAM bus lines high. The read operation Rd outputs the inverse of the value stored in the DRAM memory cell 601 on the bit line capacitance; no sense-amp or latch may be needed. This time also allows the ALU logic circuit 1605c to settle. The write operation Wr stores the new value back into the DRAM memory cell 601 and triggers the LFSR logic circuit 305c2 to shift the bits of the MSB portion by one, if needed.

Further embodiments of the present disclosure are directed to improvements in active quench and recharge schemes in lidar applications. As noted above, a SPAD may be quenched and recharged using passive or active schemes. In a passive recharge scheme, the voltage across a SPAD may be ramped through an RC circuit (e.g., a reset or recharge transistor or resistor (R) in series with the diode's resistance, and the associated capacitances (C)). However, the RC time constant may be large and/or may otherwise cause the dead time of the SPAD to be too long for operation in high-count-rate scenarios. In other situations, the RC time constant may be too short to release deep charge traps between consecutive avalanches, which may result in high afterpulsing rates (i.e., the triggering of a new avalanche due to the release of a trapped charge carrier from a previous avalanche event rather than a new incident photon) may result. Also, because the probability of inducing an avalanche may depend on the overbias of the SPAD and the overbias may gradually change during the charging of the junction capacitance, the photon detection probability may vary with time, and a long time (e.g., many multiples of the RC time constant) may be required for the overbias to reach its optimal value. In addition, because the RC time constant may depend on analog properties of the SPADs, it may vary differently across a the SPADs of a large array and between SPADs, and may also vary with operating temperature, resulting in non-uniform operation of pixels and devices.

In an active recharge scheme, a sensing circuit may be configured to sense the onset of an avalanche and, following a preset delay can actively switch current through a low resistance path to quickly recharge the SPAD. This can result in a more deterministic operation of the pixel because a respective detector may have either a charged or discharged state, and the probability of detection in a charged state may be consistent or fixed. However, because the recharging in an active recharge scheme may be almost instantaneous, large current spikes can result. For example, for a SPAD with a junction capacitance of about 20 femtofarads (fF), a detector array including 1 million SPADs may have a total capacitance (excluding interconnect capacitance) of about 20 nanofarads (nF). A difference in voltage between a discharged state and a charged state of each SPAD may be about 5V, and recharging may be completed within 500 picoseconds (psec) for desired operation. In lidar applications, all SPADs of the detector array may be discharged instantaneously, for example if a retroreflector is imaged by the detector array. Not accounting for the discharge current spike resulting from the detection event (which may be substantial), the resulting active recharge current spike to recharge a SPAD with a capacitance of 20 nF to 5V in 500 psec may be estimated as 20 nF×5V/500 psec=200 A per SPAD. If this is driven by a pulse with a 100 psec rise time, the change in current over time dI/dt=200 A/100 psec=2 kA/nsec, and the self-induced emf (ε) may be approximated by ε=−L (dI/dt). As such, with very high dI/dt, even with small inductances, e.g., resulting from packaging leads, traces, or interconnects, very large emf will be created, which will result in undesirable circuit performance.

Further embodiments of the present disclosure may provide quench and recharge circuits configured to addresses such current spikes and associated emf issues. In particular, embodiments of the present disclosure may provide active quench and recharge operations responsive to a clock signal (such as the global clock signal (Clk), as discussed above with reference to FIG. 4), and further responsive to a pixel-specific or detector-specific delay time, such that discharge and/or recharge operations of the respective pixels or detectors may be “dithered” or offset in time. For example, the detector pixels of a detector array may be divided into groups, and each group of detector pixels may be assigned or associated with a respective delay time, also described herein as a delay value. Additionally or alternatively, each detector pixel may include more than one SPAD, and each SPAD of the detector pixel may be assigned or associated with a respective delay value. The delay value may be implemented, for example, by delaying the quench or recharge signal (SPADRst), or by delaying or dithering the clock signal (Clk) that controls the sampling operation.

For example, a clocked active recharge circuit may be implemented by coupling the detection signal (VSPAD) output from a photodetector (e.g., a SPAD) to a logic circuit (e.g., one or more flip-flops arranged as a shift register) sampled by the global clock signal (Clk; which may also control operation of the emitter elements and/or bin widths) to provide the quench or recharge signal (SPADRst) to a reset or recharge circuit (e.g., a reset transistor) that resets the photodetector at a respective delay time relative to one or more other photodetectors. The recharge signal (SPADRst) may thus be generated responsive to (i) an avalanche or detection event (e.g., as indicated by a detection signal (VSPAD) output from a SPAD), and (ii) after or following the respective delay time associated with the SPAD after the next clock signal (Clk).

The logic circuit may be configured to generate a fixed delay value and/or a group-specific delay value. In some embodiments, the group-specific delay may be generated by a variable delay line. The delay value(s) may be generated by one or more delay elements within a respective pixel in some embodiments. In some embodiments, a common delay value may be generated for groups of pixels. In some embodiments, the delay value(s) may be generated globally for the detector array. In some embodiments, the delay value(s) may be generated in an analog fashion, e.g., through RC delays across the chip or IC including the detector array.

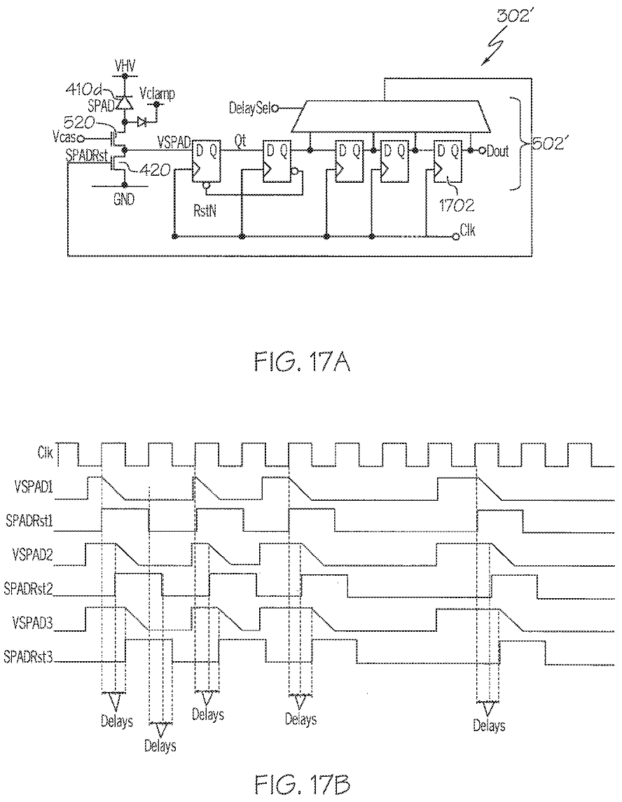

An example implementation of the clocked active recharge circuit 302′ is shown in the schematic block diagram of FIG. 17A. The clocked active recharge circuit 302′ may be a photodetector interface circuit that includes a sampling and delay circuit 502′ and a reset circuit 420. The clocked active recharge circuit 302′ provides a photodetector control circuit that couples the detection signal (VSPAD) output from a photodetector (e.g., a SPAD 410d) to a sampling and delay circuit 502′ (e.g., including multiple latches or flip-flops 1702, illustrated as a series of edge triggered D flip-flops arranged as a shift register) that is operated responsive to the global clock signal (Clk) to sample the detection signal (Photon) and provide a recharge signal (SPADRst) (which may be based on the sampled detection signal) to a reset circuit 420 (e.g., a reset transistor) that resets the SPAD 410d on the next or immediately following clock (Clk) transition. FIG. 17B is a timing diagram illustrating operation of a detector pixel including 4 SPADs 410d configured to output respective detection signals (VSPAD1, VSPAD2, VSPAD3, VSPAD4).

As shown in FIGS. 17A and 17B, the timing of the reset or recharge signals (SPADRst1, SPADRst2, SPADRst3, SPADRst4) for a respective SPAD 410d may be delayed (relative to one or more other SPADs 410d of the same pixel 410p and/or of the detector array 110) by using one or more delay elements 1702 of the sampling and delay circuit 502′. In particular, one or more delay elements 1702 may be selected responsive to assertion of a delay selection signal (DelaySel) that indicates the number of delay elements 1702. The respective timings or amount of delay of the feedback pulse providing the recharge signals (SPADRst) can thus be selected to provide different delay times based on the respective timing offsets provided by various combinations of the one or more delay elements 1702 responsive to different delay selection signals (DelaySel). The delay time or delay value can be selected on a per-detector (e.g., per-SPAD), per-pixel, or per-group of pixels basis. That is, the delay selection signal (DelaySel) may be used to select a different number of the clocked delay elements 1702 to implement variable delay times for discharging and/or recharging different SPADS or groups of SPADs. Similar to the embodiment of FIG. 5A, a bias circuit 520 (e.g., a higher voltage transistor in a cascode arrangement) is provided between the output of the SPAD 410d and the reset circuit 420 (e.g., the lower voltage reset transistor), such that no level shift electronics are needed.

In the timing diagram of FIG. 17B, while all four SPADs 410d of the detector pixel output respective detection signals (VSPAD1, VSPAD2, VSPAD3, VSPAD4) having a ‘high’ state in response to detection of photons, the reset signals (SPADRst1, SPADRst2, SPADRst3, SPADRst4) are delayed by different delay values relative to the next transition of the clock signal (Clk) after the respective photon detection events. As such, the respective recharge signals (SPADRst1, SPADRst2, SPADRst3, SPADRst4) are provided to respective reset transistors 420 at different or offset times (relative to the next transition of the clock signal Clk), thereby substantially reducing current spikes and associated emf issues.

In other embodiments, the timing of recharge signal (SPADRst) for a respective SPAD 410d may be implemented by delay of the clock signal Clk, likewise on a per-pixel or a per-detector basis. In some embodiments, such a delay in the recharge time may be inherent in providing offset detector control signals to implement histogram data that is offset by a fraction of a bin, as described in copending U.S. patent application Ser. No. 17/391,864 entitled “Methods And Systems For Power-Efficient Subsampled 3d Imaging,” the disclosure of which is incorporated by reference herein in its entirety.

Using clocked active recharge and delay schemes as described herein, even when multiple or all SPADs of a detector array fire or discharge simultaneously, the change in recharge current over time (dI/dt) is greatly reduced, thus reducing the self-induced emf as well as other resulting electrical problems (e.g., signal bounce). Since the current decreases, any I-R drops which can result in overbias non-uniformities across the array may also be reduced. According to some embodiments, the distribution (or collective duration) of the respective delays may be greater than the required active recharge time, but significantly shorter than the dead time of the SPAD. As such, the dead times of the respective SPADs may be substantially uniform, resulting in approximately uniform performance of all SPADs, regardless of their assigned delay. In contrast, some conventional active quench and recharge operations may be self-timed or asynchronous, i.e., the recharge or reset signal may be generated based on or relative to a delay from the prior avalanche, rather than based on a clock signal.

Lidar systems and arrays described herein may further be applied to ADAS (Advanced Driver Assistance Systems), autonomous vehicles, UAVs (unmanned aerial vehicles), industrial automation, robotics, biometrics, modeling, augmented and virtual reality, 3D mapping, and security. In some embodiments, the emitter elements of the emitter array may be vertical cavity surface emitting lasers (VCSELs). In some embodiments, the emitter array may include a non-native substrate having thousands of discrete emitter elements electrically connected in series and/or parallel thereon, with the driver circuit implemented by driver transistors integrated on the non-native substrate adjacent respective rows and/or columns of the emitter array, as described for example in U.S. Patent Application Publication No. 2018/0301872 to Burroughs et al., filed Apr. 12, 2018, with the United States Patent and Trademark Office, the disclosure of which is incorporated by reference herein.

Various embodiments have been described herein with reference to the accompanying drawings in which example embodiments are shown. These embodiments may, however, be embodied in different forms and should not be construed as limited to the embodiments set forth herein. Rather, these embodiments are provided so that this disclosure is thorough and complete and fully conveys the inventive concept to those skilled in the art. Various modifications to the example embodiments and the generic principles and features described herein will be readily apparent. In the drawings, the sizes and relative sizes of layers and regions are not shown to scale, and in some instances may be exaggerated for clarity. Like numbers refer to like elements (or examples of like elements) throughout.

The example embodiments are mainly described in terms of particular methods and devices provided in particular implementations. However, the methods and devices may operate effectively in other implementations. Phrases such as “example embodiment”, “one embodiment” and “another embodiment” may refer to the same or different embodiments as well as to multiple embodiments. The embodiments will be described with respect to systems and/or devices having certain components. However, the systems and/or devices may include fewer or additional components than those shown, and variations in the arrangement and type of the components may be made without departing from the scope of the inventive concepts.

The example embodiments may be described in the context of particular methods having certain steps or operations. However, the methods and devices may operate effectively for other methods having different and/or additional steps/operations and steps/operations in different orders that are not inconsistent with the example embodiments. Thus, the present inventive concepts are not intended to be limited to the embodiments shown, but are to be accorded the widest scope consistent with the principles and features described herein.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It also will be understood that, as used herein, the term “comprising” or “comprises” is open-ended, and includes one or more stated elements, steps and/or functions without precluding one or more unstated elements, steps and/or functions. The term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present inventive concepts.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed embodiments of the disclosure and, although specific terms are employed, they are used in a generic and descriptive sense only and not for purposes of limitation, the scope of the present invention being set forth in the following claims.

1. A Light Detection and Ranging (LIDAR) detector circuit, comprising:
one or more photodetector elements configured to output respective detection signals indicating respective detection events responsive to light incident thereon; and
at least one control circuit configured to receive the respective detection signals from the one or more photodetector elements, and to reset the one or more photodetector elements responsive to a transition of a clock signal after the respective detection events.

2. The LIDAR detector circuit of claim 1, wherein the clock signal comprises a global clock signal that is configured to control output of pulses of an emitter signal from a LIDAR emitter element or emitter array.

3. The LIDAR detector circuit of claim 2, wherein the at least one control circuit comprises:
a sampling circuit that is configured to sample the respective detection signals responsive to the global clock signal to generate a sampled detection signal; and
a reset circuit that is configured to reset the one or more of the photodetector elements responsive to the sampled detection signal.

4. The LIDAR detector circuit of claim 3 wherein the sampling circuit comprises a logic circuit that is free of delay logic.

5. The LIDAR detector circuit of claim 1, wherein the at least one control circuit is configured to reset the one or more photodetector elements responsive to the transition of the clock signal and after respective delay times that are associated with the one or more photodetector elements.

6. The LIDAR detector circuit of claim 5, wherein the one or more photodetector elements are detectors of a same detector pixel of a LIDAR detector array, and wherein the respective delay times of the detectors of the same detector pixel differ from one another.

7. The LIDAR detector circuit of claim 5, wherein the one or more photodetector elements are detectors of different detector pixels of a LIDAR detector array, and wherein the respective delay times of the detectors of the different detector pixels differ from one another.

8. The LIDAR detector circuit of claim 5, wherein the one or more photodetector elements are detectors of different groups of detector pixels of a LIDAR detector array, and wherein the respective delay times of the detectors of the different groups of the detector pixels differ from one another.

9. The LIDAR detector circuit of claim 5, wherein the at least one control circuit comprises:
a sampling and delay circuit that is configured to sample the respective detection signals responsive to the clock signal to generate sampled detection signals, and is configured to offset the sampled detection signals by the respective delay times; and
a reset circuit that is configured to reset the one or more of the photodetector elements responsive to the sampled detection signals that are offset by the delay circuit.

10. The LIDAR detector circuit of claim 9, wherein the sampling and delay circuit comprises one or more delay elements having respective timing offsets associated therewith, wherein the one or more delay elements are selectable responsive to a delay select signal.

11. The LIDAR detector circuit of claim 3, wherein the one or more photodetector elements are configured to operate at a different voltage level than the reset circuit, and wherein the at least one control circuit further comprises:
a bias circuit that is coupled between an output of the one or more photodetector elements and the reset circuit, wherein the reset circuit and the bias circuit are free of voltage level shift electronics.

12. The LIDAR detector circuit of claim 11, wherein the reset circuit comprises a reset transistor that is coupled to the output of the one or more photodetector elements, and wherein the bias circuit comprises a bias transistor that is coupled in a cascode arrangement between the output of the one or more photodetector elements and the reset transistor.

13. The LIDAR detector circuit of claim 2, wherein the one or more photodetector elements are detectors of a same detector pixel of a LIDAR detector array, and wherein the at least one control circuit is configured to reset the one or more photodetector elements responsive to the transition of the global clock signal after a first one of the respective detection events.

14. The LIDAR detector circuit of claim 2, further comprising:
a memory device comprising a non-transitory storage medium including a plurality of memory cells and configured to store data in respective memory bins comprising one or more of the memory cells,
wherein the at least one control circuit further comprises a memory control circuit configured to execute an increment operation to update the data in the respective memory bins responsive to the respective detection events.

15. The LIDAR detector circuit of claim 14, wherein the memory control circuit comprises a logic-based counter circuit that is configured to perform the increment operation by connecting a storage element of a respective one of the memory cells to a bit line of a preceding one of the memory cells in a same row or column of the memory device, wherein a capacitance of the bit line is greater than a capacitance of the storage element.

16. The LIDAR detector circuit of claim 15, wherein the logic-based counter circuit comprises a linear feedback shift register that is configured to execute the increment operation by sequentially shifting the data stored in the storage element of the respective one of the memory cells to a bit line of a succeeding one of the memory cells in the row using a linear feedback loop.

17. A Light Detection and Ranging (LIDAR) detector circuit, comprising:
a memory device comprising a non-transitory storage medium including a plurality of memory cells configured to store data in respective memory bins comprising one or more of the memory cells; and
at least one control circuit configured to execute an increment operation to update the data in the respective memory bins by connecting a storage element of a respective memory cell of the memory cells to a bit line of a preceding memory cell of the memory cells in a same row or column of the memory device.

18. The LIDAR detector circuit of claim 17, wherein the respective memory cell comprises a transistor that is configured to be switched to connect the storage element thereof with the bit line of the preceding memory cell, wherein a capacitance of the bit line is greater than a capacitance of the storage element.

19. The LIDAR detector circuit of claim 17, wherein the at least one control circuit further comprises:
a photodetector interface circuit that is configured to receive respective detection signals from one or more photodetector elements,
wherein the at least one control circuit is configured to execute the increment operation to update the data in the respective memory bins responsive to respective detection events indicated by the respective detection signals, and to reset the one or more photodetector elements responsive to transition of a clock signal after the respective detection events, optionally wherein the clock signal is configured to control output of pulses of an emitter signal from a LIDAR emitter element.

20. The LIDAR detector circuit of claim 19, wherein the at least one control circuit comprises a logic-based counter circuit that is configured to execute the increment operation responsive to the respective detection events.

21. The LIDAR detector circuit of claim 20, wherein the logic-based counter circuit comprises a linear feedback shift register that is configured to execute the increment operation by sequentially shifting the data stored in the storage element of the respective memory cell to a bit line of a succeeding memory cell in the same row or column of the memory device using a linear feedback loop.

22. A Light Detection and Ranging (LIDAR) detector circuit, comprising:
a detector array comprising a plurality of photodetector elements configured to output respective detection signals indicating respective detection events responsive to light incident thereon;
a memory device comprising a non-transitory storage medium including a plurality of memory cells configured to store data in respective memory bins comprising one or more of the memory cells; and
at least one control circuit configured to receive the respective detection signals from the photodetector elements, and to execute an increment operation to update the data in the respective memory bins responsive to the respective detection events, wherein the at least one control circuit comprises:
a photodetector control circuit configured to reset the photodetector elements responsive to a transition of a clock signal after the respective detection events; and/or
a memory control circuit configured to execute the increment operation by connecting a storage element of a respective memory cell of the memory cells to a bit line of a preceding memory cell of the memory cells in a same row or column of the memory device.

23. The LIDAR detector circuit of claim 22, wherein the clock signal comprises a global clock signal that is configured to control output of pulses of an emitter signal from a LIDAR emitter element or emitter array.

24. The LIDAR detector circuit of claim 23, wherein the photodetector control circuit is configured to reset the photodetector elements responsive to the transition of the clock signal and after respective delay times that are associated with the photodetector elements.

25. The LIDAR detector circuit of claim 23 or 211, wherein the at least one control circuit comprises:
a sampling circuit that is configured to sample the respective detection signals responsive to the global clock signal to generate sampled detection signals; and
a reset circuit that is configured to reset the photodetector elements responsive to the sampled detection signals.

26. The LIDAR detector circuit of claim 25, wherein the sampling circuit further comprises a delay circuit that is configured to offset the sampled detection signals by the respective delay times, and the reset circuit is configured to reset the photodetector elements responsive to the sampled detection signals that are offset by the delay circuit.

27. The LIDAR detector circuit of claim 22, wherein the memory device is a memory array comprising respective rows or columns of dynamic random access memory (DRAM) cells that define the respective memory bins, and wherein the at least one control circuit is further configured to output a readout signal responsive to a read signal that is sequentially applied to the respective rows or columns.

28. The LIDAR detector circuit of claim 27, wherein the readout signal comprises a count signal and/or a time integration signal, and wherein the at least one control circuit is configured to calculate an estimated time of arrival of photons incident on the photodetector elements based on the readout signal.

29. The LIDAR detector circuit of claim 1, wherein the at least one control circuit is configured to transmit respective strobe signals that activate the photodetector elements for respective detection windows that are differently delayed between pulses of an emitter signal that are generated responsive to the clock signal.

30. The LIDAR detector circuit of claim 29, wherein the respective detection windows correspond to respective distance subranges, and wherein the at least one control circuit is configured to transmit the respective strobe signals to activate the photodetector elements to sequentially cycle through the respective distance subranges.

31. The LIDAR detector circuit of claim 1, wherein the one or more photodetector elements comprise one or more single photon avalanche diodes (SPADs).

32. A LIDAR system comprising the LIDAR detector circuit of claim 1, wherein the LIDAR system is configured to be coupled to an autonomous vehicle such that one or more emitter elements and the one or more photodetector elements are oriented relative to an intended direction of travel of the autonomous vehicle.
